(19) United States
(12) Patent Application Publication
(10) Pub. No.: US 2014/0010912 A1
(43) Pub. Date: Jan. 9, 2014

(54) LOW CALORIE INFANT FORMULA WITH IMPROVED PHYSICAL ATTRIBUTES

(71) Applicants: Christine Clinger, New Albany, OH (US); Barbara Marriage, Columbus, OH (US)

(72) Inventors: Christine Clinger, New Albany, OH (US); Barbara Marriage, Columbus, OH (US)

(73) Assignee: ABBOTT LABORATORIES, Abbott Park, IL (US)

(21) Appl. No.: 13/977,198

(22) PCT Filed: Dec. 21, 2011
(86) PCT No.: PCT/US11/66672

§ 371 Date: Sep. 9, 2013

Related U.S. Application Data
(60) Provisional application No. 61/428,831, filed on Dec. 30, 2010.

(51) Int. Cl. A23L 1/29

(52) U.S. Cl. CPC A23L 1/296
USPC 426/2; 426/74

(57) ABSTRACT

The present disclosure is directed to low calorie infant formulas, and in particular, low calorie infant formulas that have a low buffering capacity, exhibit an increased rate of protein hydrolysis and digestion, and have an improved tolerance, as compared to full calorie infant formulas. Also disclosed are low calorie liquid infant formulas that have a reduced (i.e., “low”) micronutrient content on a per volume basis, and exhibit an overall improvement in the physical properties of the formula, as compared to low calorie liquid infant formulas having a higher micronutrient content.

### CROSS REFERENCE TO RELATED APPLICATIONS

This application claims the benefit of U.S. Provisional Application No. 61/428,831 filed Dec. 30, 2010, which disclosure is incorporated by reference in its entirety.

### FIELD OF THE DISCLOSURE

The present disclosure is directed to low calorie infant formulas, and in particular, low calorie infant formulas that have a low buffering capacity, exhibit an increased rate of protein hydrolysis and digestion, and have improved tolerance, as compared to full calorie infant formulas. Also disclosed are low calorie liquid infant formulas that have a reduced (i.e., “low”) micronutrient content on a per volume basis, and exhibit an overall improvement in the physical appearance of the formula, including a lighter color and improved stability, as compared to low calorie liquid infant formulas having a higher micronutrient content.

### BACKGROUND OF THE DISCLOSURE

There are numerous types of infant nutritional formulas that are well known and widely available. These infant formulas comprise a range of nutrients designed to meet the nutritional needs of the growing infant, and typically include fats, carbohydrates, proteins, vitamins, minerals, and other nutrients helpful for optimal infant growth and development.

Breast milk, however, is generally recognized as the best nutritional source for newborn infants. It is known that human breast milk provides good immunological benefits to the breastfed infant. Consequently, most infant formulas are designed to be closer to breast milk in terms of composition and function.

It is also known that the composition of human breast milk changes over the first few weeks following delivery of an infant. Human breast milk is referred to as colostrum during the first five days after birth, transition milk during days 6-14 after birth, and mature milk thereafter. During each stage of lactation, the corresponding human breast milk composition differs considerably. For instance, colostrum and transition milk have lower caloric densities than mature milk, as well as higher protein and lower carbohydrate concentrations. Vitamin and mineral concentrations also vary in the three defined human milk groups.

Some commercial infant formulas are similar in composition, although not identical, to mature human breast milk, and are used for both newborns as well as older infants. It has previously been generally accepted that the feeding of newborn infants should be conducted with an emphasis on encouraging infant growth, and that such growth is best accomplished by feeding the infant commercial infant formulas having a similar nutrient and energy content to mature milk.

Recently, attempts have been made to formulate infant formulas for newborns that have a lower energy content, and thus provide fewer calories during the initial weeks or months of life, than would otherwise be provided from feeding with a conventional full calorie infant formula. Previous attempts at formulating infant formulas having a low energy content have involved reducing the levels of one or more macronutrient (e.g., protein, fat, carbohydrate), while maintaining the micronutrient levels at approximately the level found in full calorie infant formulas on a per volume basis. However, the combination of reduced macronutrients and high micronutrients can result in a formula with poor physical attributes. For instance, such formulas are typically darker in color, have increased problems with sedimentation, and are more prone to separation over the shelf life of the product than are full calorie formulas.

Furthermore, some infant formula fed newborns can experience gastrointestinal (GI) intolerance problems, including loose stools, gas, and spit-up. The GI intolerance issues may be at least in part due to incomplete nutrient (e.g., protein) digestion and absorption by the infant. To address this intolerance problem, some infant formulas exclude lactose as an ingredient, while others replace intact milk protein with hydrolyzed protein to lessen the burden on the infant's digestive system.

Some formula fed infants may also experience more episodes of GI tract infection than do breast fed infants. One explanation for this phenomenon may be the low buffering capacity of human breast milk. Human breast milk is known to have lower acid buffering properties than both cow milk and cow milk-based infant formulas. The low buffering capacity of human breast milk may allow the natural level of gastric acidity in infants to be more effective in inactivating orally ingested pathogens.

It would therefore be desirable to provide a low calorie liquid infant formula that has improved physical attributes, such as a lighter color and improved stability, as compared to previously known low calorie infant formulas. It would also be desirable to provide an infant formula that has a low buffering capacity, similar to breast milk, and that also has an increased rate of protein hydrolysis and digestion and good tolerance so as to provide additional benefits to the infant.

### SUMMARY OF THE DISCLOSURE

The present disclosure is directed to low calorie liquid infant formulas having improved physical attributes. These formulas have a reduced (i.e., “low”) micronutrient content on a per volume basis, and exhibit an overall improvement in the physical appearance of the product, including a lighter color and improved stability, as compared to low calorie liquid infant formulas having a higher micronutrient content. Also disclosed are low calorie liquid and powder infant formulas that have a low buffering capacity, exhibit an increased rate of protein hydrolysis and digestion, and/or have an improved formula tolerance, as compared to conventional full calorie infant formulas. The low calorie formulas of the present disclosure, when administered to newborn infants during the first few weeks of life, provide adequate nutrition for the growth and development of the newborn.

Thus, in one embodiment, the present disclosure is directed to a low micronutrient infant formula. The formula comprises micronutrients and at least one macronutrient selected from the group consisting of protein, carbohydrate, fat, and combinations thereof, and has an energy content of from about 200 to less than 600 kilocalories per liter of formula. At least 65% of the micronutrients are included in the infant formula in an amount that is from about 30% to about 80% of conventional amounts of corresponding micronutrients on a per volume basis.

In another embodiment, the present disclosure is directed to a low micronutrient infant formula. The formula comprises micronutrients and at least one macronutrient selected from the group consisting of protein, carbohydrate, fat, and combinations thereof, and has an energy content of from about 200 to about 360 kilocalories per liter of formula. At least 45% of the micronutrients are included in the infant formula in an amount that is from about 30% to about 65% of conventional amounts of corresponding micronutrients, on a per volume basis.

In another embodiment, the present disclosure is directed to a low micronutrient infant formula. The formula comprises micronutrients and at least one macronutrient selected from the group consisting of protein, carbohydrate, fat, and combinations thereof, and has an energy content of from about 360 to about 600 kilocalories per liter of formula. At least 30% of the micronutrients are included in the infant formula in an amount that is from about 55% to about 80% of conventional amounts of corresponding micronutrients, on a per volume basis.

In another embodiment, the present disclosure is directed to a kit. The kit comprises at least one days 1-2 low micronutrient infant formula comprising micronutrients and at least one macronutrient selected from the group consisting of protein, carbohydrate, fat, and combinations thereof, and having an energy content of from about 200 to about 360 kilocalories per liter of formula, wherein at least 45% of the micronutrients are included in the infant formula in an amount that is from about 30% to about 65% of conventional amounts of corresponding micronutrients, on a per volume basis, and at least one days 3-9 low micronutrient infant formula comprising micronutrients and at least one macronutrient selected from the group consisting of protein, carbohydrate, fat, and combinations thereof, and having an energy content of from about 360 to less than 600 kilocalories per liter of formula, wherein at least 30% of the micronutrients are included in the infant formula in an amount that is from about 55% to about 80% of conventional amounts of corresponding micronutrients, on a per volume basis.

In another embodiment, the present disclosure is directed to a method for providing nutrition to an infant. The method comprises administering to the infant a low micronutrient infant formula comprising micronutrients and at least one macronutrient selected from the group consisting of protein, fat, carbohydrates, and combinations thereof, and having an energy content of from about 200 to less than 600 kilocalories per liter of formula, wherein at least 65% of the micronutrients are included in the infant formula in an amount that is from about 30% to about 80% of conventional amounts of corresponding micronutrients, on a per volume basis.

In another embodiment, the present disclosure is directed to a method for providing nutrition to an infant. The method comprises administering to the infant a low micronutrient infant formula comprising micronutrients and at least one macronutrient selected from the group consisting of protein, carbohydrate, fat, and combinations thereof, and having an energy content of from about 200 to about 360 kilocalories per liter of formula, wherein at least 45% of the micronutrients are included in the infant formula in an amount that is from about 30% to about 65% of conventional amounts of corresponding micronutrients, on a per volume basis.

It has now surprisingly been discovered that low calorie liquid infant formulas having improved physical attributes can be formulated if a sufficient amount of one or more micronutrients in the low calorie formula is generally matched to that of full calorie formulas on a per kilocalorie (kcal) basis, rather than on a per volume basis. These formulas thus have a reduced (i.e., “low”) micronutrient content on a per volume basis, and exhibit an overall improvement in the physical appearance of the product, including a lighter color and improved stability, than do low calorie liquid infant formulas having a higher micronutrient content.

It has also been discovered that the low calorie liquid or powder infant formulas have a lower buffering capacity than conventional full calorie infant formulas, and in some embodiments, have a lower buffering capacity than that of human milk. The low calorie infant formulas of the present disclosure can thus be used to regulate gastric acidity in infants, reduce the growth of pathogenic microorganisms in the infant GI tract, and promote the growth of beneficial microorganisms. The low calorie infant formulas of the present disclosure have also been found to exhibit an increased rate of protein hydrolysis and digestion, and thus have an improved formula tolerance, as compared to conventional, full calorie infant formulas.

### BRIEF DESCRIPTION OF THE DRAWINGS

FIG. 1 is a chart showing the buffering strength of various low calorie days 1-2 and days 3-9 infant formulas, as compared to control full calorie formulas and to human milk, as discussed in Example 16.

FIG. 2 is a chart showing the buffering capacity of various low calorie days 1-2 and days 3-9 infant formulas, as compared to control full calorie formulas and to human milk, as discussed in Example 16.

FIG. 3 is a chart showing the effect of HCl addition on the pH of low calorie days 1-2 and days 3-9 reconstituted powder infant formulas, as compared to a control full calorie formula, as discussed in Example 17.

FIG. 4 is a chart showing the buffering strength of low calorie days 1-2 and days 3-9 reconstituted powder infant formulas, as compared to a control full calorie formula, as discussed in Example 17.

FIG. 5 is a chart showing the buffering capacity, as measured by pH decrease following addition of 5.50 mmoles of HCl to 100 mL of formula, of low calorie days 1-2 and days 3-9 reconstituted powder infant formulas, as compared to a control full calorie formula, as discussed in Example 17.

FIG. 6 is a chart showing the buffering capacity, as measured by increase in [H+] following addition of 5.50 mmoles of HCl to 100 mL of formula, of low calorie days 1-2 and days 3-9 reconstituted powder infant formulas, as compared to a control full calorie formula, as discussed in Example 17.

FIG. 7 is a chart showing the protein molecular weight (MW) median for low calorie days 1-2 and days 3-9 reconstituted powder infant formulas following in vitro gastrointestinal digestion, as compared to a control full calorie formula, as discussed in Example 20.

FIG. 8 is a chart showing the percent total protein having a MW greater than 5000 Da for low calorie days 1-2 and days 3-9 reconstituted powder infant formulas following in vitro gastrointestinal digestion, as compared to a control full calorie formula, as discussed in Example 20.

FIG. 9 is a chart showing the amount of insoluble (indigestible) protein in the protein pellet following high speed centrifugation of low calorie days 1-2 and days 3-9 reconstituted powder infant formulas following in vitro gastrointestinal digestion, as compared to a control full calorie formula, as discussed in Example 20.

FIG. 10 is a chart showing the protein MW median for low calorie days 1-2 and days 3-9 reconstituted powder infant formulas following pancreatin digestion for 71 minutes, as compared to a control full calorie formula, as discussed in Example 23.

FIG. 11 is a chart showing the percent total protein having a MW greater than 5000 Da for low calorie days 1-2 and days 3-9 reconstituted powder infant formulas following pancreatin digestion for 71 minutes, as compared to a control full calorie formula, as discussed in Example 23.

FIG. 12 is a chart showing the particle size distribution for retort sterilized days 1-2 formulas having either a high micronutrient content (Formula 3) or a low micronutrient content (Formula 1), as discussed in Example 29.

### DETAILED DESCRIPTION OF THE DISCLOSURE

The low calorie liquid infant formulas disclosed herein may have a low micronutrient content, on a per volume basis, and improved physical attributes as compared to conventional infant formulas that have a higher micronutrient content. Further, the methods of the present disclosure utilize low calorie liquid and powder infant formulas to regulate gastric acidity in infants, reduce the growth of pathogenic microorganisms and promote the growth of beneficial microorganisms in the infant GI tract, increase the rate of protein hydrolysis and digestion, and improve formula tolerance. These and other optional features of the infant formulas and methods of the present disclosure, as well as some of the many other optional variations and additions, are described in detail hereafter.

The terms “retort” and “retort sterilized” are used interchangeably herein, and unless otherwise specified, refer to the common practice of filling a container, most typically a metal can or other similar package, with a nutritional liquid, such as a liquid infant formula, and then subjecting the liquid-filled package to the necessary heat sterilization step, to form a retort sterilized nutritional liquid product.

The terms “aseptic” and “aseptic sterilized” are used interchangeably herein, and unless otherwise specified, refer to the manufacture of a packaged product without reliance upon the above-described retort packaging step, wherein the nutritional liquid and package are sterilized separately prior to filling, and then are combined under sterilized or aseptic processing conditions to form a sterilized, aseptically packaged, nutritional liquid product.

The terms “nutritional formula” or “nutritional product” or “nutritional composition,” as used herein, are used interchangeably and, unless otherwise specified, refer to nutritional liquids, nutritional semi-liquids, nutritional solids, nutritional semi-solids, nutritional powders, nutritional supplements, and any other nutritional food product as known in the art. The nutritional solids and powders may be reconstituted to form a nutritional liquid, all of which comprise one or more of fat, protein and carbohydrate, and are suitable for oral consumption by a human. Nutritional formulas may include infant formulas.

The term “nutritional liquid,” as used herein, unless otherwise specified, refers to nutritional products in ready-to-drink liquid form, concentrated form, and nutritional liquids made by reconstituting the nutritional powders described herein prior to use.

The term “nutritional powder,” as used herein, unless otherwise specified, refers to nutritional products in flowable or scoopable form that can be reconstituted with water or another aqueous liquid prior to consumption and includes both spray dried and drymixed/dryblended powders.

The term “nutritional semi-liquid,” as used herein, unless otherwise specified, refers to those forms that are intermediate in properties, such as flow properties, between liquids and solids, examples of which include thick shakes and liquid gels.

The term “nutritional semi-solid,” as used herein, unless otherwise specified, refers to those forms that are intermediate in properties, such as rigidity, between solids and liquids, examples of which include puddings, gelatins, and doughs.

The term “infant,” as used herein, unless otherwise specified, refers to a child 12 months or younger. The term “preterm infant,” as used herein, refers to an infant born prior to 36 weeks of gestation. The term “term infant,” as used herein, refers to an infant born at or after 36 weeks of gestation.

The term “newborn infant,” as used herein, unless otherwise specified, refers to infants less than about 3 months of age, including infants from zero to about 2 weeks of age. The newborn infant may be a term or preterm infant.

The term “infant formula,” as used herein, unless otherwise specified, refers to liquid and solid nutritional products suitable for consumption by an infant. Unless otherwise specified herein, the term “infant formula” is intended to encompass both term and preterm infant formulas.

The term “preterm infant formula,” as used herein, unless otherwise specified, refers to liquid and solid nutritional products suitable for consumption by a preterm infant.

The term “micronutrient,” as used herein, refers to essential substances needed by organisms in small quantities. Non-limiting examples include vitamins, minerals, and the like.

The term “full calorie infant formula,” as used herein, refers to an infant formula in which the caloric density or energy content of the formula has not been reduced from that conventionally included in infant formula. Typically, a full calorie infant formula will have an energy content of at least 600 kcal/L, or even at least 660 kcal/L, and more typically at least 676 kcal/L, including 600 kcal/L to 800 kcal/L.

The term “low calorie infant formula,” as used herein, refers to an infant formula that has a lower energy content, on a per volume basis, than a full calorie infant formula.

The terms “high micronutrient” or “high micronutrient content,” when referring to the micronutrient content of an infant formula, means at least 80% of the micronutrients in the infant formula are present in amounts approximately the same as (typically within about 82% for most micronutrients) the amount of the micronutrients conventionally included in infant formulas.

All percentages, parts and ratios as used herein, are by weight of the total composition, unless otherwise specified. All such weights, as they pertain to listed ingredients, are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the infant formulas and methods of the present disclosure may also be substantially free of any optional or selected ingredient or feature described herein, provided that the remaining infant formulas still contains all of the required ingredients or features as described herein. In this context, and unless otherwise specified, the term “substantially free” means that the selected infant formulas contains less than a functional amount of the optional ingredient, typically less than 1%, including less than 0.5%, including less than 0.1%, and also including zero percent, by weight of such optional or selected ingredient.

The infant formulas and methods of the present disclosure may comprise, consist of, or consist essentially of the elements of the products and methods as described herein, as well as any additional or optional element described herein or otherwise useful in nutritional infant formula applications.

### Product Form

The infant formulas of the present disclosure may be formulated and administered in any known or otherwise suitable oral product form. Any solid, semi-solid, liquid, semi-liquid, or powder form, including combinations or variations thereof, are suitable for use herein, provided that such forms allow for safe and effective oral delivery to the individual of the essential ingredients as also defined herein.

Specific non-limiting examples of product forms suitable for use with products and methods disclosed herein include, for example, liquid and powder preterm infant formulas, liquid and powder term infant formulas, and liquid and powder elemental and semi-elemental formulas.

The infant formulas of the present disclosure are preferably formulated as dietary product forms, which are defined herein as those embodiments comprising the essential ingredients of the present disclosure in a product form that then contains at least one of fat, protein, and carbohydrate.

The infant formulas may be formulated with sufficient kinds and amounts of nutrients to provide a sole, primary, or supplemental source of nutrition, or to provide a specialized nutritional product for use in infants afflicted with specific diseases or conditions or with a targeted nutritional benefit.

Desirably, the infant formulas of the present disclosure are formulated for newborn infants, including both term and preterm newborn infants. Preferably, the infant formula is formulated for feeding to newborn infants within the first few weeks following birth, and more preferably for feeding to newborn infants from age zero to two weeks. In one embodiment, the infant formula is formulated for feeding to newborn infants in the first two days following birth. Such a formula is referred to herein as a “days 1-2 formula” or a “days 1-2 infant formula.” In other embodiments, the infant formula is formulated for feeding to newborn infants during days 3-9 following birth. Such a formula is referred to herein a “days 3-9 formula” or a “days 3-9 infant formula.” It is to be understood that the administration of a days 1-2 infant formula of the present disclosure is not limited to administration during only the first two days following birth, but may be administered to older infants as well in some embodiments. Similarly, the administration of a days 3-9 infant formula is not limited to administration during only days 3-9 following birth, but may be administered to infants of other ages as well in some embodiments.

### Nutritional Liquids

Nutritional liquids include both concentrated and ready-to-feed nutritional liquids. These nutritional liquids are most typically formulated as suspensions, emulsions or clear or substantially clear liquids.

Nutritional emulsions suitable for use may be aqueous emulsions comprising proteins, fats, and carbohydrates. These emulsions are generally flowable or drinkable liquids at from about 1° C. to about 25° C. and are typically in the form of oil-in-water, water-in-oil, or complex aqueous emulsions, although such emulsions are most typically in the form of oil-in-water emulsions having a continuous aqueous phase and a discontinuous oil phase.

The nutritional liquids may be and typically are shelf stable. The nutritional liquids typically contain up to about 95% by weight of water, including from about 50% to about 95%, also including from about 60% to about 90%, and also including from about 70% to about 85%, of water by weight of the nutritional liquid. The nutritional liquids may have a variety of product densities, but most typically have a density greater than about 1.03 g/mL, including greater than about 1.04 g/mL, including greater than about 1.055 g/mL, including from about 1.06 g/mL to about 1.12 g/mL, and also including from about 1.085 g/mL to about 1.10 g/mL.

The nutritional liquid may have a pH ranging from about 3.5 to about 8, but are most advantageously in a range of from about 4.5 to about 7.5, including from about 5.5 to about 7.3, including from about 6.2 to about 7.2.

Although the serving size for the nutritional liquid can vary depending upon a number of variables, a typical serving size is generally at least about 2 mL, or even at least about 5 mL, or even at least about 10 mL, or even at least about 25 mL, including ranges from about 2 mL to about 300 mL, including from about 100 mL to about 300 mL, from about 4 mL to about 250 mL, from about 150 mL to about 250 mL, from about 10 mL to about 240 mL, and from about 190 mL to about 240 mL.

### Nutritional Powders

The nutritional powders are in the form of flowable or substantially flowable particulate compositions, or at least particulate compositions. Particularly suitable nutritional powder forms include spray dried, agglomerated or dryblended powder compositions, or combinations thereof, or powders prepared by other suitable methods. The compositions can easily be scooped and measured with a spoon or similar other device, wherein the compositions can easily be reconstituted with a suitable aqueous liquid, typically water, to form a nutritional liquid, such as an infant formula, for immediate oral or enteral use. In this context, “immediate” use generally means within about 48 hours, most typically within about 24 hours, preferably right after or within 20 minutes of reconstitution.

### Energy Content

The infant formulas of the present disclosure have low energy content (used herein interchangeably with the term “caloric density”) relative to conventional term and preterm infant formulas. Specifically, the infant formulas of the present disclosure provide a caloric density or energy content of from about 200 kcal/L to less than 600 kcal/L, including from about 200 kcal/L to about 500 kcal/L, and more particularly from about 250 kcal/L to about 500 kcal/L. The days 1-2 infant formulas of the present disclosure provide a caloric density or energy content of from about 200 kcal/L to about 360 kcal/L, including from about 200 kcal/L to about 350 kcal/L, also including from about 250 kcal/L to about 350 kcal/L, from about 250 kcal/L to about 310 kcal/L, and more particularly about 250 kcal/L or about 270 kcal/L. The days 3-9 infant formulas of the present disclosure provide a caloric density or energy content of from about 360 kcal/L to less than 600 kcal/L, including from about 370 kcal/L to less than 600 kcal/L, also including from about 360 kcal/L to about 500 kcal/L, from about 390 kcal/L to about 470 kcal/L, and in particular about 406 kcal/L or about 410 kcal/L. In contrast to the infant formulas of the present disclosure, the caloric density or energy content of conventional term and preterm infant formulas, which are also referred to herein as “full calorie infant formulas,” is significantly higher, typically ranging from 600 kcal/L to 880 kcal/L.

When the infant formulas of the present disclosure are in powder form, then the powder is intended for reconstitution prior to use to obtain the above-noted caloric densities and other nutrient requirements as described herein. Likewise, when the infant formulas of the present disclosure are in a concentrated liquid form, then the concentrate is intended for dilution prior to use to obtain the requisite caloric densities and nutrient requirements. The infant formulas can also be formulated as ready-to-feed liquids already having the requisite caloric densities and nutrient requirements.

The infant formulas of the present disclosure are desirably administered to infants, and in particular newborn infants, in accordance with the methods described in detail herein. Such methods may include feedings with the infant formulas in accordance with the daily formula intake volumes described herein.

The energy component of the infant formula is most typically provided by a combination of fat, protein, and carbohydrate nutrients. The protein may comprise from about 4% to about 40% of the total calories, including from about 10% to about 30%, also including from about 15% to about 25%; the carbohydrate may comprise less than 40% of the total calories, including from about 5% to about 37%, also including less than about 36%, and also including from about 20% to about 33%; and the fat may comprise the remainder of the formula calories, most typically less than about 60% of the calories, including from about 30% to about 60%. Other exemplary amounts are set forth hereinafter.

### Micronutrients

In addition to a low energy content, in some embodiments, the infant formulas of the present disclosure are also characterized by a low micronutrient content, on a per volume basis.

As described herein, previous attempts at formulating infant formulas having a low energy content have involved reducing the levels of one or more macronutrients (e.g., protein, fat, carbohydrate), while maintaining the micronutrient level at approximately the level found in full calorie infant formulas on a per volume basis. For example, one liter of such a low calorie formula would have reduced amounts of one or more macronutrient, as compared to one liter of the full calorie formula, but approximately the same amount (typically within at least about 82% for most micronutrients) of micronutrients as are found in one liter of the full calorie formula. However, the combination of reduced macronutrients and high micronutrients results in a formula with poor physical attributes. For instance, such formulas are typically darker in color, have increased problems with sedimentation, and are more prone to separation over the shelf life of the product than are full calorie formulas.

It has now surprisingly been discovered that low calorie liquid infant formulas having improved physical attributes can be formulated if the amount of micronutrients in the low calorie formula is generally matched to that of full calorie formulas on a per kilocalorie (kcal) basis, rather than on a per volume basis. For example, 100 kcal of the low calorie formula would comprise approximately the same amount (typically within about 80% for most micronutrients) of micronutrients as are found in 100 kcal of the full calorie formula. In this example, the micronutrient content of the low calorie formula would be formulated on a 100 kcal basis. Low calorie liquid infant formulas that are formulated on a per kcal basis have a reduced (i.e., “low”) micronutrient content on a per volume basis (i.e., as compared to the same volume of a full calorie formula), and exhibit an overall improvement in the physical appearance of the formula, including a lighter color and improved stability.

Thus, in some embodiments, the present disclosure is directed to low calorie, low micronutrient infant formulas. As used herein, the term “low micronutrient” or “low micronutrient content,” when referring to infant formula, means the amount of at least a portion of the micronutrients included in the infant formula is lower than the amount of the corresponding micronutrients conventionally included in infant formula, on a per volume basis. It should be understood that it is not necessary for the amount of all micronutrients included in an infant formula to be lower than the conventional amounts of corresponding micronutrients, on a per volume basis, in order for the infant formula to be considered a low micronutrient infant formula. Reduction of a portion of the micronutrients in the infant formula, as compared to conventional amounts on a per volume basis, is sufficient.

The amount of micronutrients “conventionally included in infant formula” or “conventional amounts” of micronutrients refers to industry recognized standard amounts of micronutrients, on a per volume basis, for inclusion in infant formula in order to achieve adequate growth and development of infants. Conventional amounts of select micronutrients that may be included in infant formula, on a per volume basis, are set forth in Table A (ready-to-feed formulas) and Table B (reconstituted powder formulas) below.

TABLE A
Ready-to-Feed Formulas

| | | | Typical | Typical |
|---|---|---|---|---|
| | | | amount | amount |
| | | | for a | for an |
| | Minimum | Maximum | retort | aseptic |
| | amount | amount | formula | formula |
| Micronutrient | (per L) | (per L) | (per L) | (per L) |
| Vitamin A (IU) | 2030 | 4400 | 3110 | 3890 |
| Vitamin D (IU) | 406 | 642 | 526 | 506 |
| Vitamin E (IU) | 10.2 | 15.0 | 13.3 | 11.8 |
| Vitamin K (μg) | 54.1 | 410 | 125 | 106 |
| Thiamin (μg) | 676 | 4060 | 1220 | 1420 |
| Riboflavin (μg) | 1010 | 4000 | 2500 | 2590 |
| Vitamin B6 (μg) | 406 | 556 | 476 | 495 |
| Vitamin B12 (μg) | 1.69 | 14.0 | 4.7 | 5.4 |
| Niacin (μg) | 7100 | 21000 | 9730 | 9680 |
| Folic acid (μg) | 101 | 600 | 193 | 212 |
| Pantothenic acid (μg) | 3040 | 14400 | 6220 | 6710 |
| Biotin (μg) | 29.7 | 169 | 56.1 | 67.2 |
| Vitamin C (mg) | 60.8 | 800 | 416 | 352 |
| Choline (mg) | 109 | 203 | 127 | 120 |
| Inositol (mg) | 31.8 | 130 | 39.8 | 39.9 |
| Calcium (mg) | 528 | 620 | 585 | 581 |
| Phosphorus (mg) | 284 | 398 | 349 | 341 |
| Magnesium (mg) | 40.6 | 71.5 | 55.7 | 55.0 |
| Iron (mg) | 12.2 | 15.6 | 13.4 | 13.7 |
| Zinc (mg) | 5.07 | 14.0 | 6.46 | 6.67 |
| Manganese (μg) | 33.8 | 235 | 84.4 | 87.8 |
| Copper (μg) | 609 | 1484 | 676 | 728 |
| Iodine (μg) | 40.2 | 474 | 118 | 140 |
| Sodium (mg) | 163 | 245 | 190 | 189 |
| Potassium (mg) | 710 | 1196 | 946 | 942 |
| Chloride (mg) | 440 | 551 | 474 | 504 |
| Fluoride (μg) | — | — | 168 | 143 |
| Selenium (μg) | 12.3 | 36.1 | 24.9 | 24.3 |

TABLE B
Reconstituted Powder Formulas

| | Minimum | Maximum | Typical |
|---|---|---|---|
| | amount | amount | amount |
| Micronutrient | (per L) | (per L) | (per L) |
| Vitamin A (IU) | 2030 | 4820 | 3583 |
| Vitamin D (IU) | 406 | 642 | 563 |
| Vitamin E (IU) | 10.1 | 15.0 | 12.6 |
| Vitamin K (μg) | 54.1 | 410 | 137 |
| Thiamin (μg) | 676 | 4060 | 1560 |
| Riboflavin (μg) | 1010 | 4000 | 1500 |
| Vitamin B6 (μg) | 406 | 556 | 467 |
| Vitamin B12 (μg) | 1.69 | 14.0 | 5.85 |
| Niacin (μg) | 7100 | 21000 | 9400 |
| Folic acid (μg) | 101 | 600 | 209 |
| Pantothenic acid (μg) | 3040 | 14400 | 6750 |
| Biotin (μg) | 29.7 | 169 | 63.8 |
| Vitamin C (mg) | 60.8 | 670 | 170 |
| Choline (mg) | 108 | 203 | 123 |
| Inositol (mg) | 31.8 | 130 | 41.0 |
| Calcium (mg) | 536 | 637 | 580 |
| Phosphorus (mg) | 289 | 408 | 332 |
| Magnesium (mg) | 40.6 | 73.3 | 53.7 |
| Iron (mg) | 12.4 | 16.1 | 13.9 |
| Zinc (mg) | 5.15 | 14.4 | 6.69 |
| Manganese (μg) | 34.3 | 148 | 89.7 |
| Copper (μg) | 618 | 1519 | 720 |
| Iodine (μg) | 41.0 | 489 | 126 |
| Sodium (mg) | 165 | 251 | 201 |
| Potassium (mg) | 721 | 1235 | 1039 |
| Chloride (mg) | 446 | 565 | 486 |
| Fluoride (μg) | — | — | 116 |
| Selenium (μg) | 12.4 | 37.0 | 25.6 |

Exemplary non-limiting micronutrients that may be included in conventional infant formulas include vitamin A, vitamin D, vitamin E, vitamin K, thiamin, riboflavin, vitamin B6, vitamin B12, niacin, folic acid, pantothenic acid, biotin, vitamin C, choline, inositol, calcium, phosphorus, magnesium iron, zinc, manganese, copper, iodine, sodium, potassium, chloride, fluoride, selenium, and combinations thereof. Some exemplary conventional infant formula may include a combination of copper, phosphorus, iron, calcium, and zinc. Some other exemplary conventional infant formulas may include a combination of copper, iron and phosphorus.

In one specific embodiment, at least two of copper, phosphorus, iron, calcium, and zinc are present in the low micronutrient formulas in amount of about 5% less, or even 10% less, or even 20% less, or even 30% less, or even 50% less, or even 75% less, or even 80% less, or even 90% less than the amounts set forth in Tables A and B above. In another specific embodiment, iron and copper are present in the low micronutrient formulas in amount of about 5% less, or even 10% less, or even 20% less, or even 30% less, or even 50% less, or even 75% less, or even 80% less, or even 90% less than the amounts set forth in Tables A and B above.

It should be understood that Tables A and B do not contain an exhaustive list of suitable micronutrients that can be included in the infant formulas of the present disclosure. Further, the low micronutrient infant formulas of the present disclosure need not comprise every micronutrient listed in Tables A and B. The present disclosure contemplates infant formulas comprising any combination of one or more of the micronutrients listed in Tables A and B and/or other micronutrients known in the art as suitable for inclusion in infant formula. Standard or conventional amounts of these and other micronutrients (on a per 100 kcal basis) can readily be determined with reference to European and/or United States infant formula regulations and standards.

When determining whether the micronutrient content in an infant formula is low, on a per volume basis, as compared to conventional amounts, the amounts of “corresponding micronutrients” should be compared. In this instance, “corresponding micronutrients” refers to the same micronutrients as are present in the infant formula being evaluated. For example, if the infant formula comprises the micronutrients calcium, phosphorus, and magnesium, the amounts of these micronutrients in the infant formula should be compared to the amounts of calcium, phosphorus, and magnesium, respectively, that are conventionally included in infant formula, to determine if the amount of these micronutrients in the infant formula is “low.”

The amount of micronutrients included in the low micronutrient infant formulas of the present disclosure can be expressed as a percentage of the conventional amounts of corresponding micronutrients, on a per volume basis. For instance, in some embodiments of the present disclosure, low micronutrient infant formulas are provided wherein the micronutrients are included in the infant formula in an amount that is from about 30% to about 80% of conventional amounts of corresponding micronutrients, on a per volume basis, including from about 30% to about 65%, from about 55% to about 80%, from about 40% to about 70%, from about 40% to about 50%, and from about 60% to about 70% of conventional amounts of corresponding micronutrients, all on a per volume basis. Typically, at least 65% of the micronutrients, including at least 75%, at least 80%, at least 90%, and 100% of the micronutrients in the low micronutrient infant formulas of the present disclosure are included in the infant formula in amounts that are from about 30% to about 80% of conventional amounts of corresponding micronutrients, on a per volume basis.

In some embodiments, low micronutrient infant formulas are provided wherein the micronutrients are included in the infant formula in an amount that is from about 30% to about 65% of conventional amounts of corresponding micronutrients, on a per volume basis, including from about 35% to about 60%, from about 40% to about 50%, from about 40% to about 45%, and in particular about 40% of conventional amounts of corresponding micronutrients, all on a per volume basis. In such embodiments, typically at least 45% of the micronutrients, including at least 50%, at least 60% at least 75%, at least 80%, at least 90%, and 100% of the micronutrients in the low micronutrient infant formula are included in the infant formula in amounts that are from about 35% to about 60% of conventional amounts of corresponding micronutrients, on a per volume basis. In other embodiments, at least 10% of the micronutrients, including at least 25%, at least 50%, at least 60%, at least 75%, and at least 80% of the micronutrients in the low micronutrient infant formula are included in the infant formula in amounts that are from about 40% to about 50% of conventional amounts of corresponding micronutrients, on a per volume basis. Such low micronutrient infant formulas may include, for example, days 1-2 infant formulas.

In other embodiments, low micronutrient infant formulas are provided wherein the micronutrients are included in the infant formula in an amount that is from about 55% to about 80% of conventional amounts of corresponding micronutrients, on a per volume basis, including from about 60% to about 75%, from about 60% to about 70%, from about 60% to about 65%, and in particular about 60% of conventional amounts of corresponding micronutrients, all on a per volume basis. In such embodiments, typically at least 30% of the micronutrients, including at least 50%, at least 60%, at least 75%, at least 80%, at least 90%, and 100% of the micronutrients in the low micronutrient infant formula are included in the infant formula in amounts that are from about 55% to about 80% of conventional amounts of corresponding micronutrients, on a per volume basis. In other embodiments, at least 10%, including at least 25%, at least 50%, at least 60%, at least 75%, and at least 80%, of the micronutrients in the low micronutrient infant formula are included in the infant formula in amounts that are from about 60% to about 70% of conventional amounts of corresponding micronutrients, on a per volume basis. Such low micronutrient infant formulas may include, for example, days 3-9 infant formulas.

In some embodiments where the micronutrient includes minerals, the minerals are included in the low micronutrient infant formula in an amount that is from about 30% to about 80% of conventional amounts of corresponding minerals, on a per volume basis, including from about 30% to about 65%, from about 55% to about 80%, from about 40% to about 70%, from about 40% to about 50%, and from about 60% to about 70% of conventional amounts of corresponding minerals, all on a per volume basis. Typically, at least 10%, including at least 45%, at least 50%, at least 60%, at least 70%, at least 75%, at least 80%, at least 90%, and 100%, of the minerals in the low micronutrient infant formulas of the present disclosure are included in the infant formula in amounts that are from about 30% to about 80% of conventional amounts of corresponding minerals, on a per volume basis.

In still other embodiments, the minerals are included in the low micronutrient infant formula in an amount that is from about 30% to about 65% of conventional amounts of corresponding minerals, on a per volume basis, including from about 35% to about 60%, from about 40% to about 50%, from about 40% to about 45%, and in particular about 40% of conventional amounts of corresponding minerals, all on a per volume basis. In such embodiments, typically at least 10%, including at least 25%, at least 50%, at least 60%, at least 75%, at least 80%, at least 90%, and 100%, of the minerals in the low micronutrient infant formula are included in the infant formula in amounts that are from about 30% to about 65% of conventional amounts of corresponding minerals, on a per volume basis. In other embodiments, at least 10%, including at least 25%, at least 50%, at least 60%, at least 75%, at least 80%, at least 90%, and 100%, of the minerals in the low micronutrient infant formula are included in the infant formula in amounts that are from about 40% to about 50% of conventional amounts of corresponding minerals, on a per volume basis. Such low micronutrient infant formulas may include, for example, days 1-2 infant formulas.

In still other embodiments, the minerals are included in the low micronutrient infant formula in an amount that is from about 55% to about 80% of conventional amounts of corresponding minerals, on a per volume basis, including from about 60% to about 75%, from about 60% to about 70%, from about 60% to about 65%, and in particular about 60% of conventional amounts of corresponding minerals, all on a per volume basis. In such embodiments, typically at least 10%, including at least 25%, at least 50%, at least 60%, at least 75%, at least 80%, at least 90%, and 100%, of the minerals in the low micronutrient infant formula are included in the infant formula in amounts that are from about 55% to about 80% of conventional amounts of corresponding minerals, on a per volume basis. In other embodiments, at least 10%, including at least 25%, at least 50%, at least 60%, at least 75%, at least 80%, at least 90%, and 100%, of the minerals in the low micronutrient infant formula are included in the infant formula in amounts that are from about 60% to about 70% of conventional amounts of corresponding minerals, on a per volume basis. Such low micronutrient infant formulas may include, for example, days 3-9 infant formulas.

In some embodiments where the micronutrient includes vitamins, the vitamins are included in the low micronutrient infant formula in an amount that is from about 30% to about 80% of conventional amounts of corresponding vitamins, on a per volume basis, including from about 30% to about 65%, from about 55% to about 80%, from about 40% to about 70%, from about 40% to about 50%, and from about 60% to about 70% of conventional amounts of corresponding vitamins, all on a per volume basis. Typically, at least 45%, including at least 50%, at least 60%, at least 70%, at least 80%, at least 85%, at least 90%, and 100%, of the vitamins in the low micronutrient infant formulas of the present disclosure are included in the infant formula in amounts that are from about 30% to about 80% of conventional amounts of corresponding vitamins, on a per volume basis.

In still other embodiments, the vitamins are included in the low micronutrient infant formula in an amount that is from about 30% to about 65% of conventional amounts of corresponding vitamins, on a per volume basis, including from about 35% to about 60%, from about 40% to about 50%, from about 40% to about 45%, and in particular about 40% of conventional amounts of corresponding vitamins, all on a per volume basis. In such embodiments, typically at least 10%, including at least 25%, at least 50%, at least 60%, at least 75%, at least 80%, at least 90%, and 100%, of the vitamins in the low micronutrient infant formula are included in the infant formula in amounts that are from about 30% to about 65% of conventional amounts of corresponding vitamins, on a per volume basis. In other embodiments, at least 10%, including at least 25%, at least 50%, at least 60%, at least 75%, and at least 80%, of the vitamins in the low micronutrient infant formula are included in the infant formula in amounts that are from about 40% to about 50% of conventional amounts of corresponding vitamins, on a per volume basis. Such low micronutrient infant formulas may include, for example, days 1-2 infant formulas.

In still other embodiments, the vitamins are included in the low micronutrient infant formula in an amount that is from about 55% to about 80% of conventional amounts of corresponding vitamins, on a per volume basis, including from about 60% to about 75%, from about 60% to about 70%, from about 60% to about 65%, and in particular about 60% of conventional amounts of corresponding vitamins, all on a per volume basis. In such embodiments, typically at least 10%, including at least 25%, at least 50%, at least 60%, at least 75%, at least 80%, at least 90%, and 100%, of the vitamins in the low micronutrient infant formula are included in the infant formula in amounts that are from about 55% to about 80% of conventional amounts of corresponding vitamins, on a per volume basis. In other embodiments, at least 10%, including at least 25%, at least 50%, at least 60%, at least 75%, at least 80%, and at least 90%, of the vitamins in the low micronutrient infant formula are included in the infant formula in amounts that are from about 60% to about 70% of conventional amounts of corresponding vitamins, on a per volume basis. Such low micronutrient infant formulas may include, for example, days 3-9 infant formulas.

Suitable micronutrients for inclusion in the infant formulas of the present disclosure include vitamins or related nutrients, minerals, and combinations thereof. Non-limiting examples of suitable vitamins include vitamin A, vitamin D, vitamin E, vitamin K, thiamine, riboflavin, pyridoxine, vitamin B5, vitamin B6, vitamin B12, niacin, folic acid, pantothenic acid, biotin, vitamin C, choline, inositol, ascorbic acid, salts and derivatives thereof, and combinations thereof.

Non-limiting examples of suitable minerals that may be included in the infant formulas of the present disclosure include calcium, phosphorus, magnesium, iron, zinc, manganese, copper, iodine, sodium, potassium, molybdenum, chromium, chloride, fluoride, selenium, and combinations thereof.

Any infant formula may be formulated with a low micronutrient content as disclosed herein, including both retort and aseptic ready-to-feed nutritional liquids, concentrated nutritional liquids, and nutritional powders.

### Macronutrients

The infant formulas of the present disclosure may further comprise one or more macronutrient, in addition to the micronutrients described herein. The macronutrients include protein, fat, carbohydrate, and combinations thereof. Macronutrients suitable for use herein include any protein, fat, carbohydrate, or source thereof that is known for or otherwise suitable for use in an oral nutritional product, provided that the macronutrient is safe and effective for oral administration to infants and is otherwise compatible with the other ingredients in the infant formula.

Although total concentrations or amounts of the protein, fat, and carbohydrate may vary depending upon the product form (e.g., powder or ready-to-feed liquid) and targeted dietary needs of the intended user, such concentrations or amounts most typically fall within one of the embodied ranges described in the following table (each numerical value is preceded by the term “about”), inclusive of any other essential fat, protein, and/or carbohydrate ingredients as described herein. For powder embodiments, the amounts in the following table are amounts following reconstitution of the powder.

TABLE C

| Nutrient (g/100 mL) | Example A | Example B |
|---|---|---|
| Protein | 0.5 to 1.0 | 0.6 to 0.9 |
| Fat | 1.2 to 2.5 | 1.4 to 2.3 |
| Carbohydrate | 2.7 to 6.5 | 3.1 to 6.1 |

The total concentrations or amounts of the protein, fat, and carbohydrate may also vary depending upon whether the infant formula is a days 1-2 formula or a days 3-9 formula. The concentration of protein, fat, and carbohydrate for the days 1-2 and the days 3-9 formulas are most typically formulated within any of the embodied ranges described in the following table (each numerical value is preceded by the term “about”), inclusive of any other essential fat, protein, and/or carbohydrate ingredients as described herein. For powder embodiments, the amounts in the following table are amounts following reconstitution.

TABLE D

| | Days 1-2 Formula | | Days 3-9 Formula | |
|---|---|---|---|---|
| Nutrient | | | | |
| (g/100 mL) | Example C | Example D | Example E | Example F |
| Protein | 0.50 to 0.75 | 0.58 to 0.72 | 0.76 to 1.0 | 0.85 to 0.98 |
| Fat | 1.2 to 1.7 | 1.4 to 1.6 | 1.8 to 2.5 | 2.0 to 2.2 |
| Carbohydrate | 2.7 to 4.0 | 2.9 to 3.6 | 4.1 to 6.5 | 4.9 to 6.3 |

The level or amount of carbohydrate, fat, and protein in the infant formula (whether a powder formula or a liquid ready-to-feed or concentrated liquid) may also be characterized in addition to or in the alternative as a percentage of total calories in the infant formulas. These macronutrients for infant formulas of the present disclosure are most typically formulated within any of the caloric ranges described in the following table (each numerical value is preceded by the term “about”).

TABLE E

| Nutrient (% total calories) | Example G | Example H | Example I |
|---|---|---|---|
| Carbohydrate | 2 to 96 | 10 to 75 | 30 to 50 |
| Protein | 2 to 96 | 5 to 70 | 15 to 35 |
| Fat | 2 to 96 | 20 to 85 | 35 to 55 |
| | Example J | Example K | Example L |
| Carbohydrate | 25 to 50 | 25 to 50 | 35 to 50 |
| Protein | 10 to 30 | 5 to 30 | 7.5 to 25 |
| Fat | 1 to 20 | 2 to 20 | 30 to 60 |

### Protein

The infant formulas of the present disclosure may comprise protein in addition to the micronutrients described herein. Any known or otherwise suitable protein or protein source may be included in the infant formulas of the present disclosure, provided that such proteins are suitable for feeding to infants, and in particular, newborn infants.

Non-limiting examples of suitable protein or sources thereof for use in the infant formulas include hydrolyzed, partially hydrolyzed or non-hydrolyzed proteins or protein sources, which may be derived from any known or otherwise suitable source such as milk (e.g., casein, whey), animal (e.g., meat, fish), cereal (e.g., rice, corn), vegetable (e.g., soy), or combinations thereof. Non-limiting examples of such proteins include milk protein isolates, milk protein concentrates as described herein, casein protein isolates, extensively hydrolyzed casein, whey protein, sodium or calcium caseinates, whole cow milk, partially or completely defatted milk, soy protein isolates, soy protein concentrates, and so forth. The proteins for use herein can also include, or be entirely or partially replaced by, free amino acids known for use in nutritional products, non-limiting examples of which include L-alanine, L-aspartic acid, L-glutamic acid, glycine, L-histidine, L-isoleucine, L-leucine, L-phenylalanine, L-proline, L-serine, L-threonine, L-valine, L-tryptophan, L-glutamine, L-tyrosine, L-methionine, L-cysteine, taurine, L-arginine, L-carnitine, and combinations thereof.

### Fat

The infant formulas of the present disclosure may comprise a source or sources of fat in addition to micronutrients described herein. Suitable sources of fat for use in the infant formulas disclosed herein include any fat or fat source that is suitable for use in an oral nutritional product and is compatible with the essential elements and features of such products, provided that such fats are suitable for feeding to infants.

Non-limiting examples of suitable fats or sources thereof for use in the infant formulas described herein include coconut oil, fractionated coconut oil, soybean oil, corn oil, olive oil, safflower oil, high oleic safflower oil, high GLA-safflower oil, oleic acids, MCT oil (medium chain triglycerides), sunflower oil, high oleic sunflower oil, structured triglycerides, palm and palm kernel oils, palm olein, canola oil, flaxseed oil, borage oil, evening primrose oil, blackcurrant seed oil, transgenic oil sources, marine oils (e.g., tuna, sardine), fish oils, fungal oils, algae oils, cottonseed oils, and combinations thereof. In one embodiment, suitable fats or sources thereof include oils and oil blends including long chain polyunsaturated fatty acids (LC-PUFAs). Some non-limiting specific polyunsaturated acids for inclusion include, for example, docosahexaenoic acid (DHA), arachidonic acid (ARA), eicosapentaenoic acid (EPA), linoleic acid (LA), and the like. Non-limiting sources of arachidonic acid and docosahexaenoic acid include marine oil, egg derived oils, fungal oil, algal oil, and combinations thereof.

### Carbohydrate

The infant formulas of the present disclosure may comprise any carbohydrates that are suitable for use in an oral nutritional product, such as infant formula, and are compatible with the essential elements and features of such product.

Non-limiting examples of suitable carbohydrates or sources thereof for use in the infant formulas described herein may include maltodextrin, hydrolyzed, intact, or modified starch or cornstarch, glucose polymers, corn syrup, corn syrup solids, rice-derived carbohydrates, rice syrup, pea-derived carbohydrates, potato-derived carbohydrates, tapioca, sucrose, glucose, fructose, lactose, high fructose corn syrup, honey, sugar alcohols (e.g., maltitol, erythritol, sorbitol), artificial sweeteners (e.g., sucralose, acesulfame potassium, stevia), indigestible oligosaccharides such as fructooligosaccharides (FOS), and combinations thereof. In one embodiment, the carbohydrate may include a maltodextrin having a DE value of less than 20.

### Other Optional Ingredients

The infant formulas of the present disclosure may further comprise other optional ingredients that may modify the physical, chemical, aesthetic or processing characteristics of the products or serve as pharmaceutical or additional nutritional components when used in the targeted population. Many such optional ingredients are known or otherwise suitable for use in medical food or other nutritional products or pharmaceutical dosage forms and may also be used in the compositions herein, provided that such optional ingredients are safe for oral administration and are compatible with the essential and other ingredients in the selected product form.

Non-limiting examples of such optional ingredients include preservatives, anti-oxidants, emulsifying agents, buffers, fructooligosaccharides, galactooligosaccharides, human milk oligosaccharides and other prebiotics, pharmaceutical actives, additional nutrients as described herein, colorants, flavors, thickening agents and stabilizers, emulsifying agents, lubricants, carotenoids (e.g., beta-carotene, zeaxanthin, lutein, lycopene), and so forth, and combinations thereof.

A flowing agent or anti-caking agent may be included in the powder infant formulas as described herein to retard clumping or caking of the powder over time and to make a powder embodiment flow easily from its container. Any known flowing or anti-caking agents that are known or otherwise suitable for use in a nutritional powder or product form are suitable for use herein, non limiting examples of which include tricalcium phosphate, silicates, and combinations thereof. The concentration of the flowing agent or anti-caking agent in the nutritional product varies depending upon the product form, the other selected ingredients, the desired flow properties, and so forth, but most typically range from about 0.1% to about 4%, including from about 0.5% to about 2%, by weight of the nutritional product.

A stabilizer may also be included in the infant formulas. Any stabilizer that is known or otherwise suitable for use in a nutritional product is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the infant formula.

### Stability

The low calorie, low micronutrient liquid infant formulas of the present disclosure advantageously exhibit improved physical attributes, including improved stability, as compared to low calorie, high micronutrient formulas. Physical stability issues in liquid infant formulas often arise when the formulas are stored for extended periods of time prior to use. During this time, components of the formulas, fats for example, often separate from the aqueous components. Components of the infant formula may also fall out of suspension, forming sediment at the bottom of the formula container. Although this phase separation and sedimentation may be rectified by shaking the formula to remix formula components, such phase separation and sedimentation often results in greatly diminished consumer acceptance of the product.

It has now been discovered that the micronutrient content of low calorie liquid infant formulas may affect the stability of the infant formulas. In particular, the low calorie, low micronutrient liquid infant formulas of the present disclosure advantageously exhibit less sedimentation and less separation over the shelf life of the formulas, than do low calorie, high micronutrient formulas.

Protein Loading

A variety of measures may be used to demonstrate the stability of liquid infant formulas. For instance, one way the stability of liquid infant formulas can be determined is by measuring the protein loading levels. Protein loading levels are expressed as the protein percent of a cream layer formed following high speed centrifugation of the infant formula (the number of grams of protein per 100 grams of cream layer). Suitable techniques for determining protein loading levels are described in detail in the examples of the current disclosure.

The stability of a liquid infant formula emulsion generally increases with increasing protein loading levels. It has now been discovered that low calorie, low micronutrient retort sterilized liquid infant formulas have higher levels of protein loading than low calorie, high micronutrient retort sterilized liquid infant formulas. This was found to be the case for both days 1-2 retort infant formulas and days 3-9 retort infant formulas.

Thus, in one aspect, the present disclosure is directed to a low calorie, low micronutrient liquid infant formula having an increased protein loading level, as compared to a low calorie, high micronutrient infant formula. Preferably, the low calorie, low micronutrient liquid infant formula is a retort sterilized, ready-to-feed (RTF) formula. In embodiments where the low calorie, low micronutrient liquid infant formula is a days 1-2 infant formula, the infant formula will typically have a protein loading level of at least about 5.0%, including from about 5.0% to about 7.0%, from about 5.5% to about 6.5%, from about 5.7% to about 6.1%, and in particular about 5.9%.

In embodiments where the low calorie, low micronutrient liquid infant formula is a days 3-9 infant formula, the infant formula will typically have a protein loading value of at least about 6.0%, including from about 6.0% to about 8.0%, from about 6.5% to about 7.5%, from about 6.7% to about 7.1%, and in particular about 6.9%. Preferably, the low calorie, low micronutrient liquid infant formula is retort sterilized.

Particle Size

Another measure that may be used to demonstrate the stability of liquid infant formulas is particle size distribution and the average size of particles present in the infant formula. Particle size distribution and average particle size may be determined using any technique known in the art. One technique, described in the examples of the current disclosure, involves the use of a light scattering machine (e.g., Beckman Coulter LS 13 320), which measures the size distribution of particles suspended in a sample of the liquid infant formula using multiple wavelength light sources. Other suitable techniques may also be used.

Stability of a liquid infant formula emulsion generally increases with reducing particle size. It has now been discovered that the low calorie, low micronutrient days 1-2 retort sterilized liquid infant formulas of the present disclosure have a larger number of small particles, and a smaller average particle size for particles present in the formulas, than do low calorie, high micronutrient days 1-2 retort sterilized liquid infant formulas.

Thus, in one aspect, the present disclosure is directed to a low calorie, low micronutrient liquid infant formula having a smaller average particle size for particles present in the formula, as compared to a low calorie, high micronutrient liquid infant formula. Preferably, the low calorie, low micronutrient liquid infant formula is a retort sterilized RTF formula, and more preferably is a days 1-2 retort sterilized liquid infant formula. In embodiments where the low calorie, low micronutrient liquid infant formula is a days 1-2 infant formula, particles present in the infant formula will typically have an average particle size of from about 0.1 μm to about 1.0 μm, including from about 0.15 μm to about 0.8 μm, and from about 0.15 μm to about 0.7 μm.

Typically, for the low calorie, low micronutrient days 1-2 liquid infant formulas of the present disclosure, at least about 50%, including from about 50% to about 100%, and from about 50% to about 70% of the particles present in the infant formula will have a particle size (diameter) of from about 0.15 μm to about 0.8 μm.

Creaming Velocity

Another measure that may be used to demonstrate the stability of liquid infant formulas is creaming velocity. Creaming velocity measures the rate of movement of particles through a liquid sample, in this instance, an infant formula, and is predictive of the capacity of the infant formula to form a cream layer upon standing for extended periods of time or upon centrifugation. Creaming velocity can be calculated using the following equation:

$${v}_{cream} = \frac{2}{9} \frac{{ρ}_{fluid} - {ρ}_{particle}}{η} {gR}^{2}$$

wherein:
v_{cream} is the creaming velocity
ρ_{fluid} is the density of the formula
ρ_{particle} is the density of the particles
η is the viscosity of the formula
R is the average particle size
g is the gravitational acceleration

Stability of a liquid infant formula emulsion generally increases with decreasing creaming velocity. It has now been discovered that the low calorie, low micronutrient days 1-2 retort sterilized liquid infant formulas of the present disclosure have a lower creaming velocity, than do low calorie, high micronutrient days 1-2 retort sterilized liquid infant formulas.

Thus, in one aspect, the present disclosure is directed to a low calorie, low micronutrient liquid infant formula having a low creaming velocity, as compared to a low calorie, high micronutrient infant formula. Preferably, the low calorie, low micronutrient liquid infant formula is a retort sterilized RTF formula, and more preferably is a days 1-2 retort sterilized liquid infant formula. In embodiments where the low calorie, low micronutrient liquid infant formula is a days 1-2 infant formula, the infant formula will typically have a creaming velocity about 5.0 cm/day or less, including from about 1.0 cm/day to about 5.0 cm/day, from about 3.0 cm/day to about 3.5 cm/day, and in particular about 3.2 cm/day.

### Color

The low calorie, low micronutrient liquid infant formulas of the present disclosure also advantageously exhibit improved color, as compared to low calorie, high micronutrient formulas.

Liquid infant formulas contain a variety of nutrients that potentially interact during formulation, processing, and storage. Such interactions can distort the color of the formula with gray, beige, or similar other discolorations. Such discolorations often result in greatly diminished acceptance of the product by consumers, who typically prefer a bright, whitish colored product.

One technique that can be used to evaluate the color characteristics of an infant formula is Agtron color scores. Agtron scores as used herein are measured by conventional techniques using an Agtron 45 Spectrophotometer (available from Agtron Inc., Reno, Nev.). The Agtron scores are a measure of the percentage of reflected energy (light) from the surface of each infant formula. The more reflective or brighter in color the formula surface, the higher the Agtron score. These scores range from zero (black) to 100 (white).

It has now been discovered that the micronutrient content of low calorie liquid infant formulas affects the color of the formulas. In particular, the low calorie, low micronutrient liquid infant formulas of the present disclosure advantageously have a brighter, whiter color, as defined by Agtron score, than do low calorie, high micronutrient formulas. This was found to be the case for both retort and aseptic low calorie, low micronutrient liquid formulas. The improved color of the low calorie, low micronutrient liquid infant formulas was also observed not just upon formulation, but also after extended periods of time, in some cases at least 9 months following product formulation.

Thus, in one aspect, the present disclosure is directed to a low calorie, low micronutrient days 1-2 liquid infant formula that has an Agtron score following formulation (within a day of formulation) of at least about 45, including from about 45 to about 60, and from about 47 to about 55. Preferably, the formula is a retort sterilized RTF formula. In other embodiments, the formula has an Agtron score two months after formulation of at least about 40, including from about 40 to about 50; has an Agtron score four months after formulation of at least about 37, including from about 40 to about 50; has an Agtron score six months after formulation of at least about 37, including from about 37 to about 50; and has an Agtron score nine months after formulation of at least about 35, including from about 35 to about 45.

In another aspect, the present disclosure is directed to a low calorie, low micronutrient days 3-9 liquid retort sterilized infant formula that has an Agtron score following formulation of at least about 42, including from about 42 to about 55, and from about 45 to about 52. In other embodiments, the formula has an Agtron score three months after formulation of at least about 40, including from about 40 to about 50; and has an Agtron score six months after formulation of at least about 40, including from about 40 to about 50.

In another aspect, the present disclosure is directed to a low calorie, low micronutrient days 3-9 liquid aseptic sterilized infant formula that has an Agtron score following formulation of at least about 58, including from about 58 to about 65, and from about 60 to about 62. In other embodiments, the formula has an Agtron score two months after formulation of at least about 55, including from about 55 to about 62; has an Agtron score six months after formulation of at least about 55, including from about 55 to about 60; and has an Agtron score nine months after formulation of at least about 52, including from about 52 to about 55.

### Buffering Capacity

The low calorie infant formulas of the present disclosure (having either a high or a low micronutrient content) also advantageously exhibit improved buffering capacity, as compared to full calorie formulas.

Human breast milk is believed to contain certain factors which promote the development of a favorable intestinal bacterial flora, specifically, Bifidobacterium, which discourage the proliferation of pathogenic microbes. The growth of Bifidobacterium in the intestine of an infant is believed to be promoted by the physicochemical properties of human breast milk, particularly its high lactose content, which is a substrate for Bifidobacterium, its low protein content, and its low buffering capacity. Further, the low buffering capacity of human milk may allow the natural level of acidity in gastrointestinal (GI) tract of infants to be more effective in inactivating orally ingested pathogens. In some cases, infant formula may have a relatively high buffering capacity, which may not be completely favorable for the growth of Bifidobacterium, and may potentially impact the natural acidity of an infant's GI tract. Consequently, some formula fed infants may experience more episodes of GI tract infection as compared to breast fed infants.

It has now been discovered that the buffering capacity of infant formula is correlated to the energy content of the formula. Specifically, it has been discovered that the buffering capacity of infant formula decreases with decreasing energy content. The low calorie infant formulas of the present disclosure thus advantageously have an improved (i.e., lower) buffering capacity than full calorie infant formulas, and in some embodiments, have a lower buffering capacity than that of human milk. The low calorie infant formulas of the present disclosure can thus be used to regulate gastric acidity in infants, and in particular newborns, reduce the growth of pathogenic microorganisms in the infant GI tract, promote the growth of beneficial microorganisms, such as Bifidobacterium, and increase the effectiveness of the inactivation of orally ingested pathogens.

Buffering capacity refers generally to the ability of a liquid to resist changes in pH. There are several measures that can be used to express buffering capacity of the infant formulas of the present disclosure. For instance, buffering capacity of the infant formulas can be expressed as the increase in hydrogen ion concentration ([H+]) following addition of hydrochloric acid (HCl) to the infant formula (or to reconstituted formula for powder infant formula embodiments). Specifically, buffering capacity can be expressed as the increase in [H+] following addition of 5 mmoles of HCl to 100 mL of formula, or alternately, as the increase in [H+] following the addition of 5.50 mmoles of HCl to 100 mL of formula (or the addition of 2.75 mmoles of HCl to 50 mL of formula).

The low calorie infant formulas of the present disclosure may have a buffering capacity, expressed as the [H+] following addition of 5 mmoles of HCl to 100 mL of formula, of at least about 2.0 mM, including at least about 5.0 mM, at least about 7.0 mM, at least about 10.0 mM, at least about 13.0 mM, and at least about 17.0 mM, and/or from about 2.0 mM to about 25.0 mM, including from about 5.0 mM to about 21.0 mM, and from about 10.0 mM to about 21.0 mM. The infant formulas may be reconstituted powder formulas, retort sterilized, or aseptic sterilized, and may be a days 1-2 or a days 3-9 formula. In one embodiment, the low calorie infant formula is a days 3-9 formula, and has a buffering capacity, expressed as the [H+] following addition of 5 mmoles of HCl to 100 mL of formula at least about 2.0 mM, including at least about 5.0 mM, at least about 7.0 mM, and at least about 9.0 mM, and/or from about 2.0 mM to about 13.0 mM, including from about 8.0 mM to about 11.0 mM. In another embodiment, the low calorie infant formula is a days 1-2 formula and has a buffering capacity, expressed as the [H+] following addition of 5 mmoles of HCl to 100 mL of formula, of at least about 8.0 mM, including at least about 10.0 mM, at least about 13.0 mM, at least about 17.0 mM, and at least about 20.0 mM, and/or from about 8.0 mM to about 25.0 mM, including from about 8.0 mM to about 21.0 mM, from about 13.0 mM to about 20.0 mM, and from about 17.0 mM to about 20.0 mM.

Alternately, the buffering capacity of the infant formula can be expressed as the decrease in pH of the formula following addition of HCl to the infant formula (or to reconstituted formula for powder infant formula embodiments). Specifically, buffering capacity can be expressed as the decrease in pH following addition of 5.50 mmoles of HCl to 100 mL of formula (or the addition of 2.75 mmoles of HCl to 50 mL of formula).

Thus, in one embodiment, the low calorie infant formulas of the present disclosure is a powder infant formula, and may have a buffering capacity following reconstitution, expressed as the decrease in pH of the formula following addition of 5.50 mmoles of HCl to 100 mL of reconstituted formula, of at least about 4.20, including at least about 4.50, and at least about 4.80. In another embodiment where the low calorie infant formula is a retort sterilized RTF formula, the buffering capacity, expressed as the decrease in pH of the formula following addition of 2.75 mmoles of HCl to 50 mL of formula, is at least about 4.20, including at least about 4.30. In still another embodiment wherein the low calorie infant formula is an aseptic sterilized RTF formula, the buffering capacity, expressed as the decrease in pH of the formula following addition of 5.50 mmoles of HCl to 100 mL of formula, is at least about 4.60, including at least about 4.70.

Another measure of buffering capacity is buffering strength. Unless otherwise indicated, the buffering strength of the infant formulas of the present disclosure is expressed as the volume of 0.1 M HCl needed to decrease the pH of 50 mL of formula (or reconstituted formula for powder infant formula embodiments) from the starting pH (e.g., 6.0) to a pH of 3.0. As used herein, the term “low buffering strength” refers to a buffering strength of about 18 mL or less. Buffering strength is also expressed herein (where indicated) as mmoles of HCl required to lower the pH of 100 mL of formula from 6.0 to 3.0 and as mmoles of HCl required to lower the pH of 50 mL of formula from 6.0 to 3.0.

The low calorie infant formulas of the present disclosure may have a buffering strength, expressed as the mL of 0.1 M HCl needed to decrease the pH of 50 mL of formula (or reconstituted formula for powder infant formula embodiments) from the starting pH to a pH of 3.0, of about 18 mL or less, including about 14 mL or less, and/or including from about 9 mL to about 18 mL, including from about 10 mL to about 14 mL, and from about 14 mL to about 18 mL. In one embodiment, the low calorie infant formula is a days 3-9 formula, and has a buffering strength of about 18 mL or less, including from about 14 mL to about 18 mL, and from about 16 mL to about 17 mL. In another embodiment, the low calorie infant formula is a days 1-2 formula, and has a buffering strength of about 14 mL or less, including from about 9 mL to about 14 mL, and from about 10 mL to about 11 mL. The buffering strength of human milk typically ranges from 9 mL to 18 mL. The low calorie infant formulas of the present disclosure advantageously have a buffering strength comparable to or lower than that of human milk.

### Protein Hydrolysis and Digestion

The low calorie infant formulas of the present disclosure (having either a high or a low micronutrient content) also advantageously exhibit a faster rate of protein hydrolysis and digestion, as compared to full calorie formulas.

Two factors in determining the nutritional quality of food proteins are digestibility and bioavailability. Typically, infant formulas contain a higher level of protein than the level found in breast milk. Infant formulas are typically manufactured with higher levels of proteins to account for the assumed lower digestibility of the proteins.

Further, in some cases, the processes used during the manufacture of infant formulas may potentially have some nutritional consequences, such as lowered solubility and/or digestibility of the proteins in the formula. For example, some heat treatments over extended periods of time that are used to produce concentrated liquid and ready-to-feed infant formulas may possibly decrease digestibility of proteins in some cases. As a result of exposure to heat, proteins denature or aggregate, possibly altering their digestibility in some cases. The treatment of milk at high temperatures may also increase reactions of amino acids with sugars known as Maillard reactions. These reactions may decrease the bioavailability of amino acids by limiting the accessibility of proteolytic enzymes in some cases. As a result, some formula fed infants may potentially experience some incomplete nutrient (and in particular protein) absorption. Consequently, an infant formula having improved protein digestion would be beneficial, especially for newborn infants who are known to have lower amounts of digestive enzymes, such a gastric pepsin and intestinal pancreatin, than do older infants and adults.

It has now been discovered that the extent (used interchangeably herein with the term “rate”) of digestion (used interchangeably herein with the term “hydrolysis”) of protein in infant formula is correlated to the energy content of the formula. Specifically, it has been discovered that the rate of digestion of protein present in the infant formula increases with decreasing energy content of the formula. The low calorie infant formulas of the present disclosure thus advantageously have an improved (e.g., faster) rate of protein digestion than do full calorie infant formulas. This may result in improved infant formula tolerance and improved nutrient (and in particular protein) absorption by the infant.

There are several measures that can be used to express the rate or extent of protein digestion. For instance, the rate or extent of digestion of the proteins in the infant formulas of the present disclosure can be expressed as the median molecular weight (MW) of the proteins following an in vitro gastrointestinal digestion using pepsin and pancreatin (amylase/protease/lipase) or an in vitro pancreatin digestion. A decreasing protein MW median is indicative of a faster rate and increased extent of digestion. The procedures for these digestions are set forth in the examples.

In some embodiments, the low calorie infant formulas of the present disclosure may have a rate or extent of protein digestion, expressed as the protein MW median following in vitro gastrointestinal digestion, performed as described herein, of about 950 Daltons (Da) or less, including about 925 Da or less, about 850 Da or less, about 800 Da or less, and about 790 Da or less. For days 3-9 formulas of the present disclosure, the rate or extent of protein digestion, expressed as the protein MW median following in vitro gastrointestinal digestion, performed as described herein, is typically from about 700 Da to about 950 Da. For days 1-2 formulas, the rate or extent of protein digestion, expressed as the protein MW median following in vitro gastrointestinal digestion, performed as described herein, is typically about 825 Da or less, including about 800 Da or less, about 780 Da or less, about 750 Da or less and about 720 Da or less. Typically the rate or extent of protein digestion for days 1-2 formulas is from about 700 Da to about 800 Da.

The low calorie infant formulas of the present disclosure may have a rate or extent of protein digestion, expressed as the protein MW median following in vitro pancreatin digestion for 71 minutes, performed as described herein, of about 800 Da or less, including about 775 Da or less, and about 750 Da or less, and in particular from about 725 Da to about 775 Da for days 3-9 formulas. For days 1-2 formulas, the rate or extent of protein digestion, expressed as the protein MW median following in vitro pancreatin digestion for 71 minutes, performed as described herein, is typically about 750 Da or less, including about 725 Da or less, about 700 Da or less, and about 690 Da or less, and in particular from about 675 Da or less to about 700 Da or less.

The low calorie infant formulas of the present disclosure may have a rate or extent of protein digestion, expressed as the protein MW median following in vitro pancreatin digestion for 60 minutes, performed as described herein, of about 1000 Da or less, including about 950 Da or less, about 900 Da or less, about 850 Da or less, about 825 Da or less, and about 810 Da or less, and in particular from about 775 Da to about 825 Da.

The rate or extent of protein digestion can also be expressed as the percent of total proteins having a MW of greater than 5000 Da, following either the in vitro gastrointestinal digestion or the in vitro pancreatin digestion described herein. A smaller percentage is indicative of a faster rate and increased extent of digestion. The low calorie infant formulas of the present disclosure may have a rate or extent of protein digestion, expressed as the percent of total proteins having a MW of greater than 5000 Da following in vitro gastrointestinal digestion, performed as described herein, of about 13.5% or less, including about 12.0% or less, about 11.0% or less, about 9.0% or less, and about 6.0% or less, and in particular from about 5.0% to about 13.5% for powder formulas. In embodiments where the infant formula is retort sterilized, the rate or extent of protein digestion, expressed as the percent of total proteins having a MW of greater than 5000 Da following in vitro gastrointestinal digestion, performed as described herein, is about 8.0% or less, including about 7.0% or less, about 6.0% or less, about 5.0% or less, about 4.0% or less, and about 3.0% or less, and further including from about 2.0% to about 6.0%. In embodiments where the infant formula is aseptic sterilized, the rate or extent of protein digestion, expressed as the percent of total proteins having a MW of greater than 5000 Da following in vitro gastrointestinal digestion, performed as described herein, is about 9.0% or less, including about 7.0% or less, about 6.0% or less, about 5.0% or less, about 3.0% or less, and further including from about 2.0% to about 5.0%.

The rate or extent of protein digestion can also be expressed by the amount of insoluble protein present in the infant formula following in vitro gastrointestinal digestion, performed as described herein. Techniques for determining the level of insoluble protein are set forth in the examples of the present disclosure. A smaller amount of insoluble protein is indicative of a faster rate and increased extent of digestion.

The low calorie infant formulas of the present disclosure may have a rate or extent of protein digestion, expressed as the amount of insoluble protein in the formula following in vitro gastrointestinal digestion, performed as described herein, of about 150 mg/L or less, including about 110 mg/L or less, about 75 mg/L or less, about 50 mg/L or less, and about 25 mg/L or less, and in particular from about 20 mg/L to about 110 mg/L.

As discussed herein, processing of infant formulas, and in particular the treatment of milk products at high temperatures may increase reactions of amino acids with sugars, known as Maillard reactions. These reactions decrease the bioavailability of amino acids by limiting the accessibility of proteolytic enzymes. It has now been discovered that Maillard reactions proceed to a lesser extent in the low calorie infant formulas of the present disclosure as compared to full calorie formulas. This may be illustrated by determining the level of Maillard reaction markers in the infant formula following digestion. Specifically, the low calorie infant formulas of the present disclosure have been found to have lower levels of the Maillard reaction marker furosine, following in vitro gastrointestinal digestion performed as described herein, than do full calorie formulas.

Thus, in one aspect the present disclosure provides infant formulas that comprise, following in vitro gastrointestinal digestion performed as described herein, the Maillard reaction marker furosine in amounts (mg/100 g product) of about 2.5 or less, including about 1.5 or less, about 1.0 or less, and about 0.90 or less, and in particular from about 0.7 to about 1.0.

### Methods of Manufacture

The infant formulas of the present disclosure may be prepared by any known or otherwise effective manufacturing technique for preparing the selected product solid or liquid form. Many such techniques are known for any given product form such as nutritional liquids or powders and can easily be applied by one of ordinary skill in the art to the infant formulas described herein.

The infant formulas of the present disclosure can therefore be prepared by any of a variety of known or otherwise effective formulation or manufacturing methods. In one suitable manufacturing process, for example, at least two separate slurries are prepared, that are later blended together, heat treated, standardized, and either terminally sterilized to form a retort infant formula or aseptically processed and filled to form an aseptic infant formula. Alternately, the slurries can be blended together, heat treated, standardized, heat treated a second time, evaporated to remove water, and spray dried to form a powder infant formula.

The slurries formed may include a carbohydrate-mineral (CHO-MIN) slurry and a protein-in-oil (PIO) slurry. Initially, the CHO-MN slurry is formed by dissolving selected carbohydrates (e.g., lactose, galactooligosaccharides, etc.) in heated water with agitation, followed by the addition of minerals (e.g., potassium citrate, magnesium chloride, potassium chloride, sodium chloride, choline chloride, etc.). The resulting CHO-MIN slurry is held with continued heat and moderate agitation until it is later blended with the other prepared slurries.

The PIO slurry is formed by heating and mixing the oil (e.g., high oleic safflower oil, soybean oil, coconut oil, monoglycerides, etc.) and emulsifier (e.g., soy lecithin), and then adding oil soluble vitamins, mixed carotenoids, protein (e.g., milk protein concentrate, milk protein hydrolysate, etc.), carrageenan (if any), calcium carbonate or tricalcium phosphate (if any), and ARA oil and DHA oil (in some embodiments) with continued heat and agitation. The resulting PIO slurry is held with continued heat and moderate agitation until it is later blended with the other prepared slurries.

Water was heated and then combined with the CHO-MIN slurry, nonfat milk (if any), and the PIO slurry under adequate agitation. The pH of the resulting blend was adjusted to 6.6-7.0, and the blend was held under moderate heated agitation. ARA oil and DHA oil is added at this stage in some embodiments.

The composition is then subjected to high-temperature short-time (HTST) processing, during which the composition is heat treated, emulsified and homogenized, and then cooled. Water soluble vitamins and ascorbic acid are added, the pH is adjusted to the desired range if necessary, flavors (if any) are added, and water is added to achieve the desired total solid level. For aseptic infant formulas, the emulsion receives a second heat treatment through an aseptic processor, is cooled, and then aseptically packaged into suitable containers. For retort infant formulas, the emulsion is packaged into suitable containers and terminally sterilized. In some embodiments, the emulsions can be optionally further diluted, heat-treated, and packaged to form a desired ready-to-feed or concentrated liquid, or can be heat-treated and subsequently processed and packaged as a reconstitutable powder, e.g., spray dried, dry mixed, agglomerated.

The spray dried powder infant formula or dry-mixed powder infant formula may be prepared by any collection of known or otherwise effective techniques, suitable for making and formulating a nutritional powder. For example, when the powder infant formula is a spray-dried nutritional powder, the spray drying step may likewise include any spray drying technique that is known for or otherwise suitable for use in the production of nutritional powders. Many different spray drying methods and techniques are known for use in the nutrition field, all of which are suitable for use in the manufacture of the spray dried powder infant formulas herein. Following drying, the finished powder may be packaged into suitable containers.

### Methods of Use

The low calorie infant formulas of the present disclosure may be orally administered to infants, including term, preterm, and/or newborn infants. The low calorie infant formulas may be administered as a source of nutrition for infants and/or can be used to address one or more of the diseases or conditions discussed herein, or can be used to provide one or more of the benefits described herein, to preterm infants, term infants, and/or newborn infants. Any of this group may actually have the disease or condition, or may be at risk of getting the disease or condition (due to family history etc.), may be susceptible to the disease or condition, or may be in need of treatment/control/reduction of a certain disease or condition. The infant formulas will typically be administered daily, at intake volumes suitable for the age of the infant. As such, because some of the method embodiments disclosed herein are directed to certain subsets or subclasses of infants (e.g., those infants in need of treatment or control of a disease or condition) and not generally to the standard infant population, not all infants can benefit from all method embodiments disclosed herein.

For instance, the methods of the present disclosure may include administering one or more of the low calorie formulas of the present disclosure to an infant at the average intake volumes described herein. In some embodiments, newborn infants are provided with increasing formula volumes during the initial weeks of life. Such volumes most typically range up to about 100 mL/day on average during the first day or so of life; up to about 200 to about 700 mL/day, including from about 200 to about 600 mL/day, and also including from about 250 to about 500 mL/day, on average during the remainder of the three month newborn feeding period. It is to be understood, however, that such volumes can vary considerably depending upon the particular newborn infant and their unique nutritional needs during the initial weeks or months of life, as well as the specific nutrients and caloric density of the infant formula administered.

In some embodiments, the methods of the present disclosure may be directed to newborn infants during the initial weeks or months of life, preferably during at least the first week of life, more preferably during at least the first two weeks of life, and including up to about 3 months of life. Thereafter, the infant may be switched to a conventional infant formula, alone or in combination with human milk.

The methods described herein may comprise administering two or more different infant formulas to the infant. For instance, the infant may be administered a low calorie days 1-2 infant formula during the first two days following birth and may then subsequently be administered a low calorie days 3-9 infant formula on days 3 to 9 following birth. Optionally, the days 3-9 infant formula may be administered past day 9 following birth, or alternatively, a higher calorie formula (Including full calorie formulas) may be administered starting on day 10 following birth.

The infant formulas used in the methods described herein, unless otherwise specified, are nutritional formulas and may be in any product form, including ready-to-feed liquids, concentrated liquids, reconstituted powders, and the like. In embodiments where the infant formulas are in powder form, the method may further comprise reconstituting the powder with an aqueous vehicle, most typically water or human milk, to form the desired caloric density, which is then orally or enterally fed to the infant. The powdered formulas are reconstituted with a sufficient quantity of water or other suitable fluid such as human milk to produce the desired caloric density, as well as the desired feeding volume suitable for one infant feeding. The infant formulas may also be sterilized prior to use through retort or aseptic means.

Other embodiments are described in more detail below.

Nutrition

In one aspect, the present disclosure is directed to a method of providing nutrition to an infant. The method comprises administering to the infant any one or more of the low calorie, low micronutrient infant formulas of the present disclosure. Such methods may include the daily administration of the infant formulas, including administration at the daily intake volumes as described hereinbefore. In some embodiments, the infant is a newborn infant.

As noted above, any of the low calorie, low micronutrient infant formulas of the present disclosure may be used in this method. Specifically, the low micronutrient infant formula comprises micronutrients and at least one macronutrient selected from the group consisting of protein, carbohydrate, fat, and combinations thereof. In one embodiment, the low micronutrient infant formula has an energy content of from about 200 kcal/L to less than 600 kcal/L, wherein at least 65% of the micronutrients are included in the infant formula in an amount that is from about 30% to about 80% of conventional amounts of corresponding micronutrients, on a per volume basis. In another embodiment, the low micronutrient infant formula has an energy content of from about 200 kcal/L to about 360 kcal/L, wherein at least 45% of the micronutrients are included in the infant formula in an amount that is from about 30% to about 65% of conventional amounts of corresponding micronutrients, on a per volume basis. In still another embodiment, the low micronutrient infant formula has an energy content of from about 360 kcal/L to less than 600 kcal/L, wherein at least 30% of the micronutrients are included in the infant formula in an amount that is from about 55% to about 80% of conventional amounts of corresponding micronutrients, on a per volume basis. The low calorie infant formula may be a days 1-2 and/or a days 3-9 formula.

The method may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula) during the first two days following birth, and is subsequently administered a low calorie infant formula (having either a high or low micronutrient content) having an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth.

Buffering Capacity

It has been discovered that the buffering capacity of infant formula is correlated to the energy content of the formula. Specifically, it has been discovered that the buffering capacity of infant formula decreases with decreasing energy content. The low calorie infant formulas of the present disclosure thus advantageously have an improved (i.e., lower) buffering capacity than full calorie infant formulas, and in some embodiments, have a lower buffering capacity than human breast milk. The low calorie infant formulas of the present disclosure can thus be used to increase the level of gastric acidity in infants, and in particular newborns, and to regulate the growth of gastrointestinal flora in infants, including controlling (e.g., reducing) the growth of pathogenic microorganisms in the infant GI tract, promoting the growth of beneficial microorganisms in the infant GI tract, and increasing the effectiveness of the inactivation of orally ingested pathogens.

Without wishing to be bound to any particular theory, it is believed that the more acidic pH in the GI tract of breastfed infants, as compared to infants fed full calorie formulas, helps inactivate orally ingested pathogens, and provides a more hospitable environment for the growth of naturally occurring beneficial gastrointestinal flora. This is believed to be due, at least in part, to the low buffering capacity of human breast milk. Because the low calorie infant formulas of the present disclosure have a buffering capacity comparable to or lower than that of human breast milk, infants fed the low calorie infant formulas disclosed herein will have a level of gastric acidity more closely resembling that found in breastfed infants.

Thus, in one aspect, the present disclosure is directed to a method for increasing the level of gastric acidity (e.g., by lowering gastric pH) in an infant to about the same level of a breastfed infant. The method comprises identifying an infant having a depressed level of gastric acidity, and administering to the infant any of the low calorie infant formulas of the present disclosure. Preferably, the infant is a newborn infant.

The term “level of gastric acidity” refers to the level of acidity in the stomach, and can be measured using pH. For instance, as the pH of the gastric contents decreases, the level of gastric acidity increases. As used herein, the term “depressed level of gastric acidity” means the level of gastric acidity in the infant is lower than that typically found in breastfeed infants. Infants having a depressed level of gastric acidity can be identified as having a reduced or lower rate of pathogenic bacteria colonization in the gut. Upon administration of the low calorie infant formula of the present disclosure, the level of gastric acidity in the infant is increased to the levels typically found in breastfed infants.

As noted above, any of the low calorie infant formulas of the present disclosure may be used in this method. The low calorie infant formula may have a low micronutrient content, or, in some embodiments, may have a high micronutrient content, and may be a days 1-2 or a days 3-9 formula. In one embodiment, the infant formula has an energy content of from about 200 kcal/L to about 500 kcal/L.

The method may also further comprise administering two or more different infant formulas to the infant. For instance, in one embodiment, the infant is administered a days 1-2 formula having an energy content of from about 200 kcal/L to about 360 kcal/L during the first two days following birth, and is subsequently administered a days 3-9 formula having an energy content of from about 360 kcal/L to less than 600 kcal/L on days 3 to 9 following birth. Optionally, the days 3-9 formula may be administered past day 9 following birth, or alternatively, a higher calorie formula (Including full calorie formulas) may be administered starting on day 10 following birth. The formula (s) administered to the infant will typically be administered daily at intake volumes as described hereinbefore.

In another aspect, the present disclosure is directed to a method for increasing the level of gastric acidity in an infant comprising administering to the infant any of the low micronutrient infant formulas of the present disclosure. Preferably, the infant is a newborn infant. The low micronutrient infant formula comprises micronutrients and at least one macronutrient selected from the group consisting of protein, carbohydrate, fat, and combinations thereof. In one embodiment, the low micronutrient infant formula has an energy content of from about 200 kcal/L to less than 600 kcal/L, wherein at least 65% of the micronutrients are included in the infant formula in an amount that is from about 30% to about 80% of conventional amounts of corresponding micronutrients, on a per volume basis. In another embodiment, the low micronutrient infant formula has an energy content of from about 200 kcal/L to about 360 kcal/L, wherein at least 45% of the micronutrients are included in the infant formula in an amount that is from about 30% to about 65% of conventional amounts of corresponding micronutrients, on a per volume basis. In still another embodiment, the low micronutrient infant formula has an energy content of from about 360 kcal/L to less than 600 kcal/L, wherein at least 30% of the micronutrients are included in the infant formula in an amount that is from about 55% to about 80% of conventional amounts of corresponding micronutrients, on a per volume basis. The low calorie infant formula may be a days 1-2 and/or a days 3-9 formula.

These methods may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. In embodiments where the low calorie infant formulas have a low micronutrient content, the amounts of micronutrients included in the formulas may be any of those set forth above. The formula (s) administered to the infant will typically be administered daily at intake volumes as described hereinbefore.

In still another embodiment, the present disclosure is directed to a method for regulating growth of beneficial gastrointestinal flora in an infant. The method comprises identifying an infant having an imbalance in the growth of gastrointestinal flora, and administering to the infant any of the low calorie infant formulas of the present disclosure. Preferably, the infant is a newborn infant.

For purposes of the present disclosure, the growth of gastrointestinal flora can be regulated by either promoting the growth of microorganisms beneficial to GI health, and/or by controlling the growth of pathogenic microorganisms. The growth of pathogenic microorganisms can be controlled by suppressing, inhibiting, killing, inactivating, destroying or otherwise interfering with the growth of the pathogenic microorganisms, such that the growth rate of these microorganisms is slowed or stopped. Infants having an imbalance in the growth of GI flora include infants in which the levels of one or more pathogenic microorganism in the infant's GI tract is higher than the levels typically found in breastfed infants and/or the levels of one or more beneficial microorganism in the infant's GI tract are lower than the levels typically found in breastfeed infants. Such infants may be identified by a lower rate of pathogenic bacteria colonization in the gut. Upon administration of the low calorie infant formula of the present disclosure, the level of gastric acidity in the infant is increased to the levels similar to those typically found in breastfed infants, resulting in a GI environment which promotes the growth of beneficial microorganisms and controls the growth of pathogenic microorganisms.

As noted above, any of the low calorie infant formulas of the present disclosure may be used in this method. The low calorie infant formula may have a low micronutrient content, or, in some embodiments, may have a high micronutrient content, and may be a days 1-2 or a days 3-9 formula. In one embodiment, the infant formula has an energy content of from about 200 kcal/L to about 500 kcal/L of formula.

The method may also further comprise administering two or more different infant formulas to the infant. For instance, in one embodiment, the infant is administered a days 1-2 formula having an energy content of from about 200 kcal/L to about 360 kcal/L during the first two days following birth, and is subsequently administered a days 3-9 formula having an energy content of from about 360 kcal/L to less than 600 kcal/L on days 3 to 9 following birth. Optionally, the days 3-9 formula may be administered past day 9 following birth, or alternatively, a higher calorie formula (Including full calorie formulas) may be administered starting on day 10 following birth. The formula (s) administered to the infant will typically be administered daily at intake volumes as described hereinbefore.

In another aspect, the present disclosure is directed to a method for regulating the growth of gastrointestinal flora in an infant comprising administering to the infant any of the low micronutrient infant formulas of the present disclosure. Preferably, the infant is a newborn infant. The low micronutrient infant formula may be any of those set forth above.

These methods may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. In embodiments where the low calorie infant formulas have a low micronutrient content, the amounts of micronutrients included in the formulas may be any of those set forth above. The formula (s) administered to the infant will typically be administered daily at intake volumes as described hereinbefore.

Beneficial microorganisms refer to those microorganisms that maintain the microbial ecology of the GI tract, and show physiological, immuno-modulatory, and/or antimicrobial effects, such that their presence has been found to prevent and treat GI diseases and/or disorders. Non-limiting examples of beneficial microorganisms include any one or more of the following: the genus Lactobacillus including L. acidophilus, L. amylovorus, L. brevis, L. bulgaricus, L. casei spp. Casei, L. casei spp. Rhamnosus, L. crispatus, L. delbrueckii ssp. Lactis, L. fermentum, L. helvaticus, L. johnsonii, L. paracasei, L. pentosus, L. plantarum, L. reuteri, and L. sake; the genus Bifidobacterium including B. animalis, B. bifidum, B. breve, B. infantis, and B. longum; the genus Pediococcus including P. acidilactici; the genus Propionibacterium including P. acidipropionici, P. freudenreichii, P. jensenii, and P. theonii; and the genus Streptococcus including S. cremoris, S. lactis, and S. thermophilus; and combinations thereof.

Non-limiting examples of pathogenic microorganisms whose growth may be controlled by the methods disclosed herein include any one or more of the following: bacteria such as the genus Clostridum including C. difficile; Escherichia coli (E. coli); Vibrio sp.; Salmonella sp.; Shigella sp.; Camphylobacter sp.; Aeromonas sp.; Staphylococcus sp.; Pseudomonas sp.; and parasites such as Giardia sp.; and Cryptosporidium sp.; and combinations thereof.

Protein Digestion and Hydrolysis

It has been discovered that the rate and extent of digestion of protein in infant formula is correlated to the energy content of the formula. Specifically, it has been discovered that the rate of digestion of proteins in infant formula increases with decreasing energy content of the formula. The low calorie infant formulas of the present disclosure thus advantageously have an improved (e.g., faster) rate of digestion as compared to full calorie infant formulas. The low calorie infant formulas of the present disclosure can thus be used to improve formula tolerance, protein digestion, and nutrient (and in particular protein) absorption in infants, and in particular newborns.

Thus, in one aspect, the present disclosure is directed to a method for improving protein digestion in an infant. The method comprises identifying an infant experiencing incomplete protein digestion, and administering to the infant any of the low calorie infant formulas of the present disclosure. Preferably, the infant is a newborn infant.

As used herein, the term “improving protein digestion” includes increasing the rate of digestion (or hydrolysis) of protein present in the infant formula and/or increasing the extent to which protein in the infant formula is digested when contacted with digestive enzymes. This improvement in protein digestion can be determined using any of the measures described herein, including, for example, the protein median weight following digestion, the percent of total protein having a molecular weight of greater than 5000 Daltons following digestion, and/or the amount of insoluble protein present in the formula following digestion.

As used herein, the term “incomplete protein digestion” means the amount of protein, present in nutritional products consumed by the infant, that is actually digested is lower than the amount typically digested by breastfed infants. Infants experiencing incomplete protein digestion may show signs of formula intolerance, and may thus be identified using any of the symptoms of formula intolerance described herein. Infants experiencing incomplete protein digestion can also be identified by diarrhea, loose stools, gas, and/or bloating. Upon administration of a low calorie infant formula of the present disclosure, the rate and extent of protein digestion is improved.

As noted above, any of the low calorie infant formulas of the present disclosure may be used in this method. The low calorie infant formula may have a low micronutrient content, or, in some embodiments, may have a high micronutrient content, and may be a days 1-2 and/or a days 3-9 formula. In one embodiment, the infant formula has an energy content of from about 200 kcal/L to less than 600 kcal/L of formula.

The method may also further comprise administering two or more different infant formulas to the infant. For instance, in one embodiment, the infant is administered a days 1-2 formula having an energy content of from about 200 kcal/L to about 360 kcal/L during the first two days following birth, and is subsequently administered a days 3-9 formula having an energy content of from about 360 kcal/L to less than 600 kcal/L on days 3 to 9 following birth. Optionally, the days 3-9 formula may be administered past day 9 following birth, or alternatively, a higher calorie formula (Including full calorie formulas) may be administered starting on day 10 following birth. The formula (s) administered to the infant will typically be administered daily at intake volumes as described hereinbefore.

In another aspect, the present disclosure is directed to a method for improving protein digestion in an infant comprising administering to the infant any of the low micronutrient infant formulas of the present disclosure. Preferably, the infant is a newborn infant. The low micronutrient infant formula comprises micronutrients and at least one macronutrient selected from the group consisting of protein, carbohydrate, fat, and combinations thereof. In one embodiment, the low micronutrient infant formula has an energy content of from about 200 kcal/L to less than 600 kcal/L, wherein at least 65% of the micronutrients are included in the infant formula in an amount that is from about 30% to about 80% of conventional amounts of corresponding micronutrients, on a per volume basis. In another embodiment, the low micronutrient infant formula has an energy content of from about 200 kcal/L to about 360 kcal/L, wherein at least 45% of the micronutrients are included in the infant formula in an amount that is from about 30% to about 65% of conventional amounts of corresponding micronutrients, on a per volume basis. In still another embodiment, the low micronutrient infant formula has an energy content of from about 360 kcal/L to less than 600 kcal/L, wherein at least 30% of the micronutrients are included in the infant formula in an amount that is from about 55% to about 80% of conventional amounts of corresponding micronutrients, on a per volume basis. The low calorie infant formula may be a days 1-2 and/or a days 3-9 formula.

These methods may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. In embodiments where the low calorie infant formulas have a low micronutrient content, the amounts of micronutrients included in the formulas may be any of those set forth above. The formula (s) administered to the infant will typically be administered daily at intake volumes as described hereinbefore.

In still another embodiment, the present disclosure is directed to a method of improving protein absorption in an infant. The method comprises identifying an infant experiencing incomplete protein absorption; and administering to the infant any of the low calorie infant formulas of the present disclosure. Infants experiencing incomplete protein absorption may be identified using any of the criteria described herein for identifying infants experiencing incomplete protein digestion.

As noted above, any of the low calorie infant formulas of the present disclosure may be used in this method. The low calorie infant formula may have a low micronutrient content, or, in some embodiments, may have a high micronutrient content, and may be a days 1-2 or a days 3-9 formula. In one embodiment, the infant formula has an energy content of from about 200 kcal/L to less than 600 kcal/L of formula.

The method may also further comprise administering two or more different infant formulas to the infant. For instance, in one embodiment, the infant is administered a days 1-2 formula having an energy content of from about 200 kcal/L to about 360 kcal/L during the first two days following birth, and is subsequently administered a days 3-9 formula having an energy content of from about 360 kcal/L to less than 600 kcal/L on days 3 to 9 following birth. Optionally, the days 3-9 formula may be administered past day 9 following birth, or alternatively, a higher calorie formula (Including full calorie formulas) may be administered starting on day 10 following birth. The formula (s) administered to the infant will typically be administered daily at intake volumes as described hereinbefore.

In another aspect, the present disclosure is directed to a method of improving protein absorption in an infant comprising administering to the infant any of the low micronutrient infant formulas of the present disclosure. Preferably, the infant is a newborn infant. The low micronutrient infant formula may be any of those set forth above.

These methods may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. In embodiments where the low calorie infant formulas have a low micronutrient content, the amounts of micronutrients included in the formulas may be any of those set forth above. The formula (s) administered to the infant will typically be administered daily at intake volumes as described hereinbefore.

Tolerance

The present disclosure is also directed to a method of improving the infant formula tolerance of an infant. Infant formula intolerance is a non-immune system associated reaction that may be evidenced by behavior or by stool or feeding pattern changes, such as increased spit-up or vomiting, an increased number of stools, more watery stools, black stools, and increased fussiness. Infant formula intolerance is most often associated with gastrointestinal symptoms (e.g., stool patterns, gas, spit-up) as well as behavior characteristics (e.g., acceptance of formula, fussing and crying). Infants suffering from formula intolerance may also experience gastroesophageal reflux.

It has now unexpectedly been discovered that infants have a greater tolerance for an infant formula having a low energy content than for full calorie formulas. Specifically, it has been discovered that low calorie infant formulas demonstrate a faster rate of protein hydrolysis and digestion, produce less Maillard reaction products (which cannot be broken down and absorbed) upon consumption, and have a faster rate of gastric emptying than do full calorie formulas. The faster gastric emptying leads to decreased gastroesophageal reflux, and improved tolerance of the formula.

The low calorie infant formulas of the present disclosure may thus be used to decrease the incidence of gas, and/or spit up in infants. The low calorie infant formulas of the present disclosure may also be used to increase the rate of gastric emptying in the infant and reduce the degree of Maillard reaction products resulting from formula consumption, as compared to full calorie infant formulas.

The low calorie infant formulas can be administered to any infant, preterm or full term, and especially any infant that can benefit from receiving an infant formula having a low energy content that also has high tolerance. In some embodiments, the low calorie infant formulas of the present disclosure are administered to newborn infants.

Thus, in one aspect, the present disclosure is directed to a method of improving the infant formula tolerance of an infant. The method comprises identifying an infant having infant formula intolerance and administering to the infant any one or more of the low calorie infant formulas of the present disclosure. Infants having infant formula intolerance can include infants having any one or more of the symptoms of formula intolerance. Such symptoms include, but are not limited to, stool or feeding pattern changes, such as increased spit-up or vomiting, an increased number of stools, more watery stools, black stools, increased fussiness, crying, gas, and lack of acceptance of formula. Upon administration of a low calorie infant formula of the present disclosure, some or all of the symptoms of formula intolerance may be reduced or eliminated.

As noted above, any of the low calorie infant formulas of the present disclosure may be used in this method. The low calorie infant formula may have a low micronutrient content, or, in some embodiments, may have a high micronutrient content, and may be a days 1-2 or a days 3-9 formula. In one embodiment, the low calorie infant formula has an energy content of from about 200 to about 600 kilocalories per liter of formula.

The method may also further comprise administering two or more different infant formulas to the infant. For instance, in one embodiment, the infant is administered a days 1-2 formula having an energy content of from about 200 kcal/L to about 360 kcal/L during the first two days following birth, and is subsequently administered a days 3-9 formula having an energy content of from about 360 kcal/L to less than 600 kcal/L on days 3 to 9 following birth. Optionally, the days 3-9 formula may be administered past day 9 following birth, or alternatively, a higher calorie formula (Including full calorie formulas) may be administered starting on day 10 following birth. The formula (s) administered to the infant will typically be administered daily at intake volumes as described hereinbefore.

In another aspect, the present disclosure is directed to a method for improving the infant formula tolerance of an infant comprising administering to the infant any of the low micronutrient infant formulas of the present disclosure. Preferably, the infant is a newborn infant. The low micronutrient infant formula comprises micronutrients and at least one macronutrient selected from the group consisting of protein, carbohydrate, fat, and combinations thereof. In one embodiment, the low micronutrient infant formula has an energy content of from about 200 kcal/L to less than 600 kcal/L, wherein at least 65% of the micronutrients are included in the infant formula in an amount that is from about 30% to about 80% of conventional amounts of corresponding micronutrients, on a per volume basis. In another embodiment, the low micronutrient infant formula has an energy content of from about 200 kcal/L to about 360 kcal/L, wherein at least 45% of the micronutrients are included in the infant formula in an amount that is from about 30% to about 65% of conventional amounts of corresponding micronutrients, on a per volume basis. In still another embodiment, the low micronutrient infant formula has an energy content of from about 360 kcal/L to less than 600 kcal/L, wherein at least 30% of the micronutrients are included in the infant formula in an amount that is from about 55% to about 80% of conventional amounts of corresponding micronutrients, on a per volume basis. The low calorie infant formula may be a days 1-2 or a days 3-9 formula.

These methods may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. In embodiments where the low calorie infant formulas have a low micronutrient content, the amounts of micronutrients included in the formulas may be any of those set forth above. The formula (s) administered to the infant will typically be administered daily at intake volumes as described hereinbefore.

In still another embodiment, the present disclosure is directed to a method for inhibiting gastroesophageal reflux in an infant. The method comprises identifying an infant having gastroesophageal reflux, and administering to the infant any one or more of the low calorie infant formulas of the present disclosure. Preferably, the infant is a newborn infant.

Gastroesophageal reflux (GER) occurs when stomach contents reflux into the esophagus and out of the mouth, resulting in regurgitation, spitting up, and/or vomiting. Symptoms of GER include spitting up, vomiting, coughing, irritability, poor feeding, bloody stool, and combinations thereof GER may also occur when infants cough, cry, or strain. For purposes of the present disclosure, the term “inhibiting gastroesophageal reflux” is intended to include treating, preventing, and/or decreasing the rate of occurrence of GER and/or at least one of its symptoms. Without wishing to be bound to any particular theory, it is believed that the low calorie infant formula of the present disclosure has a faster rate of gastric emptying (i.e., the rate at which contents pass through the stomach), which leads to decreased gastroesophageal reflux, as compared to full calorie formulas.

As noted above, any of the low calorie infant formulas of the present disclosure may be used in this method. The low calorie infant formula may have a low micronutrient content, or, in some embodiments, may have a high micronutrient content, and may be a days 1-2 or a days 3-9 formula. In one embodiment, the infant formula has an energy content of from about 200 kcal/L to less than 600 kcal/L of formula.

The method may also further comprise administering two or more different infant formulas to the infant. For instance, in one embodiment, the infant is administered a days 1-2 formula having an energy content of from about 200 kcal/L to about 360 kcal/L during the first two days following birth, and is subsequently administered a days 3-9 formula having an energy content of from about 360 kcal/L to less than 600 kcal/L on days 3 to 9 following birth. Optionally, the days 3-9 formula may be administered past day 9 following birth, or alternatively, a higher calorie formula (including full calorie formulas) may be administered starting on day 10 following birth. The formula (s) administered to the infant will typically be administered daily at intake volumes as described hereinbefore.

In another aspect, the present disclosure is directed to a method for inhibiting gastroesophageal reflux in an infant comprising administering to the infant any one or more of the low micronutrient infant formulas of the present disclosure. Preferably, the infant is a newborn infant. The low micronutrient infant formula may be any of those set forth above.

These methods may also further comprise administering two or more different infant formulas to the infant. For instance, in one embodiment, the infant is administered a low calorie infant formula (having either a high or low micronutrient content) having an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. In embodiments where the low calorie infant formulas have a low micronutrient content, the amounts of micronutrients included in the formulas may be any of those set forth above. The formula (s) administered to the infant will typically be administered daily at intake volumes as described hereinbefore.

In another aspect, the present disclosure is directed to a method for increasing the rate of gastric emptying in an infant comprising administering to the infant any one or more of the low micronutrient infant formulas of the present disclosure. Preferably, the infant is a newborn infant. The low micronutrient infant formula may be any of those set forth above.

These methods may also further comprise administering two or more different infant formulas to the infant. For instance, in one embodiment, the infant is administered a low calorie infant formula (having either a high or low micronutrient content) that has an energy content of from about 200 kcal/L to about 360 kcal/L (e.g., a days 1-2 formula), during the first two days following birth. The infant may then subsequently be administered a low calorie infant formula (having either a high or low micronutrient content) that has an energy content of from about 360 kcal/L to less than 600 kcal/L (e.g., a days 3-9 formula) on days 3 to 9 following birth. Optionally, the days 3-9 formula may be administered past day 9 following birth, or alternatively, a higher calorie formula (Including full calorie formulas) may be administered starting on day 10 following birth. The amounts of micronutrients included in the formulas may be any of those set forth above. The formula (s) administered to the infant will typically be administered daily at intake volumes as described hereinbefore.

### Kits

The present disclosure further provides kits comprising two or more of the low calorie infant formulas of the present disclosure.

For instance, in some embodiments, the kit may comprise at least one days 1-2 formula and at least one days 3-9 formula. Preferably, the kit will comprise sufficient amounts of the days 1-2 formula to provide an infant with adequate nutrition during the first two days following birth, and sufficient amounts of the days 3-9 formula to provide an infant with adequate nutrition for at least days 3-9 following birth. The infant formulas included in the kit may be in any suitable form, including, for example, a ready-to-feed liquid, a concentrated liquid, a powder, or combinations thereof. The kit may include low calorie, low micronutrient formulas and/or low calorie, high micronutrient formulas.

Optionally, the kits may further comprise instructions for use of the kit. For instance, the instructions may describe how to use the formulas, e.g., may indicate that the days 1-2 formulas should be administered on the first two days following birth and that the days 3-9 formulas should be administered on days 3-9 following birth; may describe a daily administration schedule for the formulas; and/or may describe how to practice any of the methods described in the present disclosure. The instructions may further optionally describe how to reconstitute any powder infant formulas included in the kit.

In addition to the infant formulas and optional instructions, the kit can also include additional components, such as one or more baby bottles of various sizes, one or more baby bottle liners of various sizes, baby bottle nipples, and the like.

### EXAMPLES

The following examples illustrate specific embodiments and/or features of the infant formulas and methods of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

Unless otherwise specified, the retort sterilized and aseptic sterilized formulas prepared in accordance with the manufacturing methods described herein, are ready-to-feed liquid formulas.

### Examples 1-8

In these examples, 2 oz. retort sterilized days 1-2 and days 3-9 infant formulas were prepared with either high or low micronutrient content. The ingredients used to prepare the formulas are set forth in Tables 1 and 2 below.

TABLE 1
Days 1-2 Formulas

| | | Formula 1 | Formula 2 | Formula 3 | Formula 4 |
|---|---|---|---|---|---|
| | Units | (days 1-2) | (days 1-2) | (days 1-2) | (days 1-2) |
| Energy | Kcal/L | 270 | 270 | 250 | 250 |
| Micronutrient content | | low | low | high | high |
| Ingredients (Amount Per | | | | | |
| 1000 Kg batch) | | | | | |
| Water | kg | Q.S. | Q.S. | Q.S. | Q.S. |
| Lactose | kg | 23.2 | 23.1 | 15.5 | 15.2 |
| Nonfat Dry Milk | kg | 11.0 | 11.0 | 11.0 | 11.3 |
| Galactooligosaccharides | kg | 4.40 | 4.40 | 4.40 | 4.40 |
| High Oleic Safflower Oil | kg | 5.34 | 5.35 | 5.33 | 5.37 |
| Soy Oil | kg | 4.00 | 4.00 | 3.99 | 4.00 |
| Coconut Oil | kg | 3.82 | 3.82 | 3.81 | 3.84 |
| Whey Protein | kg | 2.70 | 2.70 | 2.70 | 2.86 |
| Concentrate | | | | | |
| 1N KOH | g | 1340 | 1.40 | 1340 | 1340 |
| Potassium Hydroxide | g | 67.0 | 70.0 | 67.0 | 67.0 |
| Calcium Phosphate | g | 327.1 | 249.8 | 1090 | 770.2 |
| Dibasic | | | | | |
| Potassium Citrate | g | 3.10 | 1.24 | 1370 | 1240 |
| Calcium Citrate | g | 351.0 | 578.8 | 752.6 | 768.9 |
| Ascorbic Acid | g | 727.5 | 727.5 | 727.5 | 727.5 |
| ARA Oil | g | 367.9 | 367.9 | 367.9 | 367.9 |
| Nucleotide-Choline | g | 328.5 | 328.5 | 328.5 | 328.5 |
| Premix | | | | | |
| Dicalcium Phosphate | g | — | — | — | — |
| Magnesium Chloride | g | 16.8 | 102.6 | 460.9 | 450.7 |
| Sodium Chloride | g | 45.7 | 28.5 | 325.8 | 186.7 |
| Soy Lecithin | g | 143.0 | 143.0 | 143.0 | 143.0 |
| Distilled Monoglycerides | g | 143.0 | 143.0 | 143.0 | 143.0 |
| Vitamin/Mineral/Taurine Premix | g | 31.4 | 57.1 | 157.0 | 157.0 |
| Taurine | g | 9.60 | 17.5 | 48.0 | 48.0 |
| m-Inositol | g | 6.97 | 12.7 | 34.85 | 34.85 |
| Zinc Sulfate | g | 3.21 | 5.85 | 16.07 | 16.07 |
| Niacinamide | g | 2.05 | 3.73 | 10.24 | 10.24 |
| Calcium Pantothenate | g | 1.23 | 2.23 | 6.14 | 6.14 |
| Ferrous Sulfate | g | 1.07 | 1.95 | 5.37 | 5.37 |
| Cupric Sulfate | mg | 377 | 686 | 1890 | 1890 |
| Thiamine Chloride | mg | 318 | 578 | 1590 | 1590 |
| HCL | | | | | |
| Riboflavin | mg | 140 | 255 | 701 | 701 |
| Pyridoxine HCL | mg | 128 | 234 | 642 | 642 |
| Folic Acid | mg | 43.2 | 78.5 | 216 | 216 |
| Manganese Sulfate | mg | 36.6 | 66.5 | 183 | 183 |
| Biotin | mg | 12.4 | 22.6 | 62.0 | 62.0 |
| Sodium Selenate | mg | 7.44 | 13.5 | 37 | 37 |
| Cyanocobalamin | mg | 0.990 | 1.8 | 4.95 | 4.95 |
| DHA Oil | g | 137.9 | 137.9 | 137.9 | 137.9 |
| Potassium Chloride | g | 46.3 | 52.4 | As needed | 60.7 |
| Choline Chloride | g | 58.9 | 21.5 | 88.9 | 54.0 |
| Ferrous Sulfate | g | 5.80 | 23.20 | 60.9 | 60.9 |
| Carrageenan | g | 175.0 | 175.0 | 175.0 | 175.0 |
| Vitamin A, D3, E, K1 | g | 22.8 | 19.0 | 47.5 | 47.5 |
| RRR α-Tocopherol Acetate | g | 4.61 | 3.84 | 9.6 | 9.6 |
| Vitamin A Palmitate | mg | 867 | 721.5 | 1800 | 1800 |
| Vitamin K1 | mg | 50.2 | 41.8 | 104.5 | 104.5 |
| Vitamin D3 | mg | 6.08 | 5.06 | 12.65 | 12.65 |
| Citric Acid | g | 29.8 | 29.8 | 29.8 | 29.8 |
| Mixed Carotenoid Premix | g | 23.8 | 23.8 | 23.8 | 23.8 |
| Lycopene | mg | 119 | 119 | 119 | 119 |
| Lutein | mg | 50 | 50 | 50 | 50 |
| Beta-carotene | mg | 26.2 | 26.2 | 26.2 | 26.2 |
| Inositol | g | 33.1 | 6.6 | 12.9 | 12.9 |
| L-Carnitine | g | 6.38 | 1.31 | 6.38 | 3.28 |
| Riboflavin | mg | — | 466.0 | 882 | 882 |

TABLE 2
Days 3-9 Formulas

| | | Formula 5 | Formula 6 | Formula 7 | Formula 8 |
|---|---|---|---|---|---|
| | Units | (days 3-9) | (days 3-9) | (days 3-9) | (days 3-9) |
| Energy | Kcal/L | 406 | 406 | 406 | 410 |
| Micronutrient content | | low | low | low | high |
| Ingredients (Amount | | | | | |
| Per 1000 Kg Batch) | | | | | |
| Water | kg | Q.S. | Q.S. | Q.S. | Q.S. |
| Lactose | kg | 37.0 | 37.2 | 37.5 | 35.50 |
| Nonfat Dry Milk | kg | 16.3 | 16.2 | 16.2 | 16.30 |
| Galactooligosaccharides | kg | 8.63 | 8.63 | 8.63 | 8.63 |
| High Oleic Safflower Oil | kg | 7.72 | 7.72 | 7.72 | 7.72 |
| Soy Oil | kg | 5.78 | 5.78 | 5.78 | 5.78 |
| Coconut Oil | kg | 5.52 | 5.52 | 5.52 | 5.51 |
| Whey Protein Concentrate | kg | 4.00 | 4.00 | 4.00 | 4.00 |
| 1N KOH | kg | 1.34 | 1.34 | 0.8035 | 1.34 |
| Potassium Hydroxide | g | 67.0 | 67.0 | 40.2 | 67.0 |
| Calcium Phosphate | kg | 0.309 | — | — | — |
| Dibasic | | | | | |
| Potassium Citrate | kg | 0.00186 | 0.00186 | 0.00186 | 1.06 |
| Calcium Citrate | g | 687.6 | 583.5 | 583.5 | 261.1 |
| Ascorbic Acid | g | 727.5 | 727.5 | 436.5 | 727.5 |
| ARA Oil | g | 378.2 | 378.2 | 378.2 | 378.2 |
| Nucleotide-Choline | g | 319.7 | 319.7 | 319.7 | 319.7 |
| Premix | | | | | |
| Ultra Micronized | g | — | 226.8 | 226.8 | 1470 |
| Tricalcium Phosphate | | | | | |
| Magnesium Chloride | g | 122.5 | 147.7 | 147.7 | 288.1 |
| Sodium Chloride | g | — | — | | 235.8 |
| Soy Lecithin | g | 206.0 | 206.0 | 206.0 | 206.0 |
| Distilled Monoglycerides | g | 206.0 | 206.0 | 206.0 | 206.0 |
| Vitamin/Mineral/Taurine Premix | g | 85.6 | 115.7 | 115.7 | 142.7 |
| Taurine | g | 26.2 | 35.4 | 35.4 | 43.6 |
| m-Inositol | g | 19.0 | 25.7 | 25.7 | 31.7 |
| Zinc Sulfate | g | 8.76 | 11.8 | 11.8 | 14.61 |
| Niacinamide | g | 5.59 | 7.55 | 7.55 | 9.31 |
| Calcium Pantothenate | g | 3.35 | 4.53 | 4.53 | 5.58 |
| Ferrous Sulfate | g | 2.93 | 3.96 | 3.96 | 4.88 |
| Cupric Sulfate | g | 1.03 | 1.39 | 1.39 | 1.71 |
| Thiamine Chloride | g | 0.8667 | 1.17 | 1.17 | 1.44 |
| HCL | | | | | |
| Riboflavin | mg | 382.2 | 516.6 | 516.6 | 637 |
| Pyridoxine HCl | mg | 350.1 | 473.2 | 473.2 | 584 |
| Folic Acid | mg | 117.7 | 159.1 | 159.1 | 196 |
| Manganese Sulfate | mg | 99.7 | 134.7 | 134.7 | 166 |
| Biotin | mg | 33.8 | 45.7 | 45.7 | 56.0 |
| Sodium Selenate | mg | 20.3 | 27.4 | 27.4 | 34 |
| Cyanocobalamin | mg | 2.7 | 3.64 | 3.64 | 4.5 |
| DHA Oil | g | 137.9 | 137.9 | 137.9 | 137.9 |
| Potassium Chloride | g | 108.7 | 111.3 | 111.3 | 129.5 |
| Choline Chloride | g | 32.4 | 32.4 | 32.4 | 88.9 |
| Ferrous Sulfate | g | 34.8 | 37.5 | 37.5 | 60.9 |
| Carrageenan | g | 175.0 | 175.0 | 175.0 | 175.0 |
| Vitamin A, D3, E, K1 | g | 28.5 | 30.2 | 30.2 | 44.8 |
| RRR α-Tocopherol | g | 5.8 | 6.11 | 6.11 | 9.1 |
| Acetate | | | | | |
| Vitamin A Palmitate | g | 1.08 | 1.15 | 1.15 | 1.7 |
| Vitamin K1 | mg | 62.7 | 66.4 | 66.4 | 98.5 |
| Vitamin D3 | mg | 7.6 | 8.04 | 8.04 | 11.9 |
| Citric Acid | g | 29.8 | 29.8 | 29.8 | 29.8 |
| Mixed Carotenoid Premix | g | 23.8 | 23.8 | 23.8 | 23.8 |
| Lycopene | mg | 119 | 119 | 119 | 119 |
| Lutein | mg | 50 | 50 | 50 | 50 |
| Beta-carotene | mg | 26.2 | 26.2 | 26.2 | 26.2 |
| Inositol | g | — | — | — | 12.9 |
| L-Carnitine | g | 1.97 | 2.31 | 2.31 | 5.51 |
| Riboflavin | g | 0.70 | 0.699 | 0.699 | 1.50 |
| Vitamin A | mg | — | 770 | 770 | 780 |
| Vitamin A Palmitate | mg | — | 420 | 420 | 425 |
| Copper Sulfate | mg | — | — | — | 391 |

The formulas were prepared by making at least two separate slurries that were later blended together, heat treated, standardized, and terminally sterilized. Initially, a carbohydrate-mineral slurry was prepared by dissolving the selected carbohydrates (e.g. lactose, galactooligosacchardies) in water at 74-79° C., followed by the addition of citric acid, magnesium chloride, potassium chloride, potassium citrate, choline chloride, and sodium chloride. The resulting slurry was held under moderate agitation at 49-60° C. until it was later blended with the other prepared slurries.

A protein-in-oil slurry was prepared by combining the high oleic safflower oil, coconut oil, monoglycerides, and soy lecithin under agitation and heating to 66-79° C. Following a 10-15 minute hold time, soybean oil, oil soluble vitamin premix, mixed carotenoid premix, carrageenan, vitamin A, calcium citrate, dicalcium phosphate, ARA oil, DHA oil, and whey protein concentrate were then added to the slurry. The resulting oil slurry was held under moderate agitation at 49-60° C. until it was later blended with the other prepared slurries.

Water was heated to 49-60° C. and then combined with the carbohydrate-mineral slurry, nonfat milk, and the protein-in-oil slurry under adequate agitation. The pH of the resulting blend was adjusted with potassium hydroxide. This blend was held under moderate agitation at 49-60° C.

The resulting blend was heated to 74-79° C., emulsified through a single stage homogenizer to 900-1100 psig, and then heated to 144-147° C., for about 5 seconds. The heated blend was passed through a flash cooler to reduce the temperature to 88-93° C. and then through a plate cooler to further reduce the temperature to 74-85° C. The cooled blend was then homogenized at 2900-3100/400-600 psig, held at 74-85° C. for 16 seconds, and then cooled to 2-7° C. Samples were taken for analytical testing. The mixture was held under agitation at 2-7° C.

A water-soluble vitamin (WSV) solution and an ascorbic acid solution were prepared separately and added to the processed blended slurry. The vitamin solution was prepared by adding the following ingredients to water with agitation: potassium citrate, ferrous sulfate, WSV premix, L-carnitine, copper sulfate, riboflavin, inositol, and the nucleotide-choline premix. The ascorbic acid solution was prepared by adding potassium hydroxide and ascorbic acid to a sufficient amount of water to dissolve the ingredients. The ascorbic acid solution pH was then adjusted to 5-9 with potassium hydroxide.

The blend pH was adjusted to a specified pH range of 7.1-7.6 with potassium hydroxide (varied by product) to achieve optimal product stability. The completed product was then filled into suitable containers and terminally sterilized.

### Examples 9-11

In these examples, 32 oz. aseptic sterilized days 3-9 infant formulas were prepared with either high or low micronutrient content. The ingredients used to prepare the formulas are set forth in Table 3 below.

TABLE 3

| | | Formula 9 | Formula 10 | Formula 11 |
|---|---|---|---|---|
| | Units | (days 3-9) | (days 3-9) | (days 3-9) |
| Energy | Kcal/L | 406 | 410 | 410 |
| Micronutrient Content | | low | high | high |
| Ingredients | | Amount per 1000 kg batch | | |
| Water | kg | Q.S. | Q.S. | Q.S. |
| Lactose | kg | 37.0 | 33.7 | 34.03 |
| Nonfat Dry Milk | kg | 16.3 | 17.0 | 16.47 |
| Galactooligosaccharides | kg | 8.63 | 8.63 | 8.63 |
| High Oleic Safflower Oil | kg | 7.72 | 7.83 | 7.72 |
| Soy Oil | kg | 5.78 | 5.87 | 5.78 |
| Coconut Oil | kg | 5.52 | 5.60 | 5.51 |
| Whey Protein Concentrate | kg | 4.00 | 4.19 | 4.05 |
| 1N KOH | kg | 1.85 | 1.85 | 1.85 |
| Potassium Hydroxide | g | 92.5 | 92.5 | 92.5 |
| Calcium Citrate | g | 675.0 | 716.8 | 993.9 |
| Calcium Phosphate Dibasic | g | 577.4 | 1170 | 1390 |
| Ascorbic Acid | g | 431.7 | 431.7 | 431.7 |
| ARA Oil | g | 378.2 | 378.2 | 378.2 |
| Nucleotide-Choline Premix | g | 319.7 | 319.7 | 319.7 |
| Soy Lecithin | g | 206.0 | 206.0 | 206.0 |
| Distilled Monoglycerides | g | 206.0 | 206.0 | 206.0 |
| Carrageenan | g | 200.0 | 240.0 | 200.0 |
| DHA Oil | g | 137.9 | 137.9 | 137.9 |
| Magnesium Chloride | g | 128.9 | 279.3 | 285.9 |
| Potassium Chloride | g | 118.5 | 213.9 | 122.4 |
| Choline Chloride | g | 88.9 | 54.0 | 88.9 |
| Vitamin/Mineral/Taurine Premix | g | 41.4 | 142.7 | 142.7 |
| Taurine | g | 12.7 | 43.6 | 43.6 |
| m-Inositol | g | 9.19 | 31.7 | 31.7 |
| Zinc Sulfate | g | 4.24 | 14.61 | 14.61 |
| Niacinamide | g | 2.70 | 9.31 | 9.31 |
| Calcium Pantothenate | g | 1.62 | 5.58 | 5.58 |
| Ferrous Sulfate | g | 1.42 | 4.88 | 4.88 |
| Cupric Sulfate | mg | 497 | 1710 | 1710 |
| Thiamine Chloride HCl | mg | 419 | 1440 | 1440 |
| Riboflavin | mg | 185 | 637 | 637 |
| Pyridoxine HCl | mg | 169 | 584 | 584 |
| Folic Acid | mg | 56.9 | 196 | 196 |
| Manganese Sulfate | mg | 48.2 | 166 | 166 |
| Biotin | mg | 16.4 | 56.0 | 56.0 |
| Sodium Selenate | mg | 9.81 | 34 | 34 |
| Cyanocobalamin | mg | 1.3 | 4.5 | 4.5 |
| Sodium Chloride | g | 32.1 | 65.4 | 231.9 |
| Vitamin A, D3, E, K1 | g | 30.9 | 44.8 | 44.8 |
| RRR Alpha-Tocopheryl Acetate | g | 6.24 | 9.1 | 9.1 |
| Vitamin A Palmitate | g | 1.17 | 1.7 | 1.7 |
| Vitamin K1 | mg | 67.9 | 98.5 | 98.5 |
| Vitamin D3 | mg | 8.22 | 11.9 | 11.9 |
| Citric Acid | g | 29.8 | 29.8 | 29.8 |
| Inositol | g | 25.8 | 12.9 | 12.9 |
| Mixed Carotenoid Premix | g | 23.8 | 23.8 | 23.8 |
| Lycopene | mg | 119 | 119 | 119 |
| Lutein | mg | 50 | 50 | 50 |
| Beta-Carotene | mg | 26.2 | 26.2 | 26.2 |
| Ferrous Sulfate | g | 16.2 | 60.9 | 60.9 |
| L-Carnitine | g | 5.51 | 3.28 | 5.51 |
| Potassium Citrate | g | 3.10 | 895.0 | 1060 |
| Riboflavin | mg | 599 | 1500 | 1500 |
| Vitamin A | mg | — | 780 | 780 |
| Vitamin A Palmitate | mg | — | 425 | 425 |
| Copper Sulfate | mg | — | — | 391 |

The formulas were prepared by making at least two separate slurries that were later blended together, heat treated, standardized, and then aseptically processed and filled. Initially, a carbohydrate-mineral slurry was prepared by dissolving the selected carbohydrates (e.g. lactose, galactooligosacchardies) in water at 74-79° C., followed by the addition of citric acid, magnesium chloride, potassium chloride, potassium citrate, choline chloride, and sodium chloride (minerals varied by formulation). The resulting slurry was held under moderate agitation at 49-60° C. until it was later blended with the other prepared slurries.

A protein-in-oil slurry was prepared by combining high oleic safflower oil, coconut oil, monoglycerides, and soy lecithin under agitation and heating to 66-79° C. Following a 10-15 minute hold time, soybean oil, oil soluble vitamin premix, mixed carotenoid premix, carrageenan, calcium citrate, calcium phosphate dibasic, ARA oil, DHA oil, and whey protein concentrate were added to the slurry. The resulting oil slurry was held under moderate agitation at 49-60° C. until it was later blended with the other prepared slurries.

Water was heated to 49-60° C. and then combined with the carbohydrate-mineral slurry, nonfat milk, and the protein-in-oil slurry under adequate agitation. The pH of the resulting blend was adjusted with potassium hydroxide. This blend was held under moderate agitation at 49-60° C.

The resulting blend was heated to 74-79° C., emulsified through a single stage homogenizer to 900-1100 psig, and then heated to 144-147° C., for about 5 seconds. The heated blend was passed through a flash cooler to reduce the temperature to 88-93° C., and then through a plate cooler to further reduce the temperature to 74-85° C. The cooled blend was then homogenized at 2900-3100/400-600 psig, held at 74-85° C. for 16 seconds, and then cooled to 2-7° C. Samples were taken for analytical testing. The mixture was held under agitation at 2-7° C.

A water-soluble vitamin (WSV) solution and an ascorbic acid solution were prepared separately and added to the processed blended slurry. The vitamin solution was prepared by adding the following ingredients to water with agitation: potassium citrate, ferrous sulfate, WSV premix, L-carnitine, riboflavin, inositol, and the nucleotide-choline premix. The ascorbic acid solution was prepared by adding potassium hydroxide and ascorbic acid to a sufficient amount of water to dissolve the ingredients. The ascorbic acid solution pH was then adjusted to 5-9 with potassium hydroxide.

The blend pH was adjusted to a pH range of 6.8-7.0 with potassium hydroxide to achieve optimal product stability. The standardized blend then received a second heat treatment through an aseptic processor. The blend was preheated to 63-74° C. and homogenized at 200 psig. The blend was further heated to 141-144° C. and passed through a hold tube. The heated blend was cooled to reduce the temperature to 74-85° C., and then homogenized at 1200/200 psig. The blend was further cooled to 16-27° C., and then aseptically filled into suitable containers at 21° C.

### Examples 12-15

In these examples, powder days 1-2 and days 3-9 infant formulas were prepared with either low or high micronutrient content. The ingredients used to prepare the formulas are set forth in Table 4 below.

TABLE 4

| | | Formula 12 | Formula 13 | Formula 14 | Formula 15 |
|---|---|---|---|---|---|
| | | (days 1-2) | (days 1-2) | (days 3-9) | (days 3-9) |
| Kcal/L | | 270 | 250 | 406 | 420 |
| Nutrient Content | | low | high | low | high |
| Ingredients | Units | Amount per 1000 kg batch | | | |
| Lactose | kg | 376.90 | 288.6 | 406.4 | 380.4 |
| Non-Fat Dry Milk | kg | 223.00 | 223.1 | 201.1 | 201.1 |
| High Oleic Safflower Oil | kg | 109.30 | 108.5 | 97.69 | 97.7 |
| Galactooligosaccharides | kg | 81.70 | 84.7 | 104.1 | 104.10 |
| Soy Oil | kg | 81.70 | 82.4 | 74.21 | 74.2 |
| Coconut Oil | kg | 75.30 | 75.9 | 68.36 | 68.4 |
| Whey Protein Concentrate | kg | 48.80 | 54.9 | 49.50 | 49.5 |
| Potassium Citrate | kg | 8.52 | 42.6 | 11.12 | 22.0 |
| ARA Oil | kg | 7.20 | 7.43 | 4.643 | 4.57 |
| Whey Protein Hydrolysate | kg | 6.80 | — | — | — |
| Calcium Carbonate | kg | 3.76 | — | 2.839 | 1.5 |
| Tricalcium Phosphate | kg | — | 24.1 | 2.638 | 10.9 |
| DHA Oil | kg | 2.70 | 2.8 | 1.752 | 1.7 |
| Ascorbic Acid | kg | 2.03 | 3.20 | 2.006 | 2.0 |
| Nucleotide-Choline Premix | kg | 2.01 | 5.9 | 2.346 | 3.6 |
| Potassium Chloride | kg | 1.154 | — | 1.219 | — |
| Vitamin/Mineral/Taurine | kg | 1.116 | 2.8 | 1.116 | 1.7 |
| Premix | | | | | |
| Taurine | g | 341 | 859.9 | 341 | 528.9 |
| m-Inositol | g | 248 | 624.3 | 248 | 384.0 |
| Zinc Sulfate | g | 114 | 287.9 | 114 | 177.1 |
| Niacinamide | g | 72.8 | 183.5 | 72.8 | 112.9 |
| Calcium Pantothenate | g | 43.7 | 110 | 43.7 | 67.7 |
| Ferrous Sulfate | g | 38.2 | 96.3 | 38.2 | 59.2 |
| Cupric Sulfate | g | 13.4 | 33.8 | 13.4 | 20.8 |
| Thiamine Chloride HCl | g | 11.3 | 28.5 | 11.3 | 17.5 |
| Riboflavin | g | 4.98 | 12.60 | 4.98 | 7.72 |
| Pyridoxine HCl | g | 4.58 | 11.5 | 4.58 | 7.07 |
| Folic Acid | g | 1.53 | 3.9 | 1.53 | 2.4 |
| Manganese Sulfate | g | 1.3 | 3.27 | 1.3 | 2.01 |
| Biotin | mg | 441 | 1100 | 441 | 683 |
| Sodium Selenate | mg | 264 | 666.1 | 264 | 410 |
| Cyanocobalamin | mg | 35.1 | 88.6 | 35.1 | 54.5 |
| Soy Lecithin | kg | 1.120 | 1.1 | 1.112 | 1.1 |
| Magnesium Chloride | kg | 0.839 | 6.6 | 1.437 | 3.4 |
| Potassium Chloride | kg | — | 2.6 | — | 2.3 |
| Ascorbyl Palmitate | g | 459.25 | 348.1 | 313.5 | 313.6 |
| Carotenoid Premix | g | 454.02 | 463.0 | 286.6 | 286.6 |
| Lycopene | g | 2.27 | 2.27 | 1.43 | 1.41 |
| Lutein | mg | 953 | 953 | 602 | 589.9 |
| Beta-Carotene | mg | 499 | 499 | 315 | 308.9 |
| Ferrous Sulfate | g | 453.5 | 1100 | 453.6 | 703.1 |
| Choline Chloride | g | 432.1 | 1100 | 432.1 | 670.2 |
| Sodium Chloride | g | 388.0 | 7100 | 1138 | 2900 |
| Vitamin A, D3, E, K1 | g | 385.24 | 914.5 | 327.3 | 568.8 |
| RRR α-Tocopheryl | g | 77.9 | 184.9 | 66.2 | 115.0 |
| Acetate | | | | | |
| Vitamin A Palmitate | g | 14.63 | 34.7 | 12.4 | 21.6 |
| Vitamin K1 | mg | 847 | 2000 | 720 | 1250 |
| Vitamin D3 | mg | 102.3 | 243.5 | 87.1 | 151.4 |
| Mixed Tocopherols | g | 246.3 | 153.4 | 138.2 | 138.2 |
| L-Carnitine | g | 26.3 | 66.3 | 23.3 | 40.8 |
| Riboflavin | g | 3.2 | 8.0 | 3.2 | 4.9 |
| 1N Potassium Hydroxide | | as needed | as needed | as needed | as needed |

The formulas were prepared by making at least two separate slurries that were later blended together, heat treated, standardized, heat treated a second time, evaporated to remove water, and finally spray dried. Initially, a carbohydrate-mineral slurry was prepared by dissolving the selected carbohydrates (e.g. lactose, galactooligosaccharides) in water at 60-71° C., followed by the addition of magnesium chloride, potassium chloride, potassium citrate, choline chloride, and sodium chloride (minerals vary depending on formulation). The resulting slurry was held under moderate agitation at 49-60° C. until it was later blended with the other prepared slurries.

A protein-in-oil slurry was prepared by combining high oleic safflower oil, soybean oil, and coconut oil at 49-60° C., followed by the addition of ascorbyl palmitate, mixed tocopherols, soy lecithin, oil soluble vitamin premix, whey protein concentrate, whey protein hydrolysate (in some cases), carotenoid premix, and calcium carbonate (and/or tricalcium phosphate). The resulting oil slurry was held under moderate agitation at 38-49° C. until it was later blended with the other prepared slurries.

Water, the carbohydrate-mineral slurry, non fat milk, and the protein-in-oil slurry, were combined under adequate agitation. The pH of the resulting blend was adjusted with potassium hydroxide. This blend was held under moderate agitation at 49-60° C. The ARA and DHA oil were added following the pH adjustment and prior to processing.

The resulting blend was heated to 71-77° C., emulsified through a single stage homogenizer to a maximum of 300 psig, and then heated to 82-88° C., for about 5 seconds. The heated blend was passed through a flash cooler to reduce the temperature to 77-82° C. and then through a plate cooler to further reduce the temperature to 71-77° C. The cooled blend was then homogenized at 2400-2600/400-600 psig, held at 74-85° C. for 16 seconds, and then cooled to 2-7° C. Samples were taken for analytical testing. The mixture was held under agitation at 2-7° C.

A water-soluble vitamin (WSV) solution and an ascorbic acid solution were prepared separately and added to the processed blended slurry. The vitamin solution was prepared by adding the following ingredients to water with agitation: potassium citrate, ferrous sulfate, WSV premix, L-carnitine, riboflavin, and the nucleotide-choline premix (specific ingredients vary by formulation). The ascorbic acid solution was prepared by adding potassium hydroxide and ascorbic acid to a sufficient amount of water to dissolve the ingredients. The ascorbic acid solution pH was then adjusted to 5-9 with potassium hydroxide.

The blend pH was adjusted to a pH range of 6.60-6.90 with potassium hydroxide to achieve optimal product stability. The standardized blend then received a second heat treatment. The blend was originally heated to 66-82° C., and then further heated to 118-124° C. for about 5 seconds. The heated blend was then passed through a flash cooler to reduce the temperature to 71-82° C. Following heat treatment, the blend was evaporated down to a density of 1.15-1.17 g/mL.

The evaporated blend was passed through a spray drier, targeting a moisture level of 2.5% in the finished powder. The finished powder then underwent agglomeration with water as the binder solution. The completed product was then packaged into suitable containers.

### Example 16

In this example, the effect of energy content on the buffering capacity and buffering strength of infant formula was evaluated. Specifically, the buffering capacity and buffering strength of various days 1-2 and days 3-9 infant formulas of the present disclosure were determined and compared to the buffering capacity and buffering strength of a commercially available powder control infant formula, a commercially available ready-to-feed 2 oz. retort sterilized control infant formula, a commercially available ready-to-feed 32 oz. aseptic sterilized control infant formula, and human milk. The ingredients used to prepare the control formulas are set forth in Table 5 below.

TABLE 5

| | | Control | Control | Control |
|---|---|---|---|---|
| | | Formula 1 | Formula 2 | Formula 3 |
| | | (powder) | (retort) | (aseptic) |
| Kcal/L | | 676 | 676 | 676 |
| Ingredients | Units | Amount per 1000 kg batch | | |
| Water | kg | — | Q.S. | Q.S. |
| Condensed Skim Milk | kg | 698.5 | 83.61 | 86.64 |
| Lactose | kg | 386.0 | 54.88 | 54.7 |
| High Oleic Safflower Oil | kg | 114.4 | 14.07 | 14.0 |
| Soy Oil | kg | 85.51 | 10.54 | 10.5 |
| Coconut Oil | kg | 78.76 | 10.05 | 10.0 |
| Galactooligosaccharides | kg | 69.50 | 8.630 | 8.60 |
| Whey Protein Concentrate | kg | 51.08 | 6.120 | 6.52 |
| Potassium Citrate | g | 9168 | 518.3 | 418.07 |
| Calcium Carbonate | g | 4054 | 508.5 | 477.16 |
| ARA Oil | g | 2949 | 355.6 | 378.16 |
| Nucleotide-Choline Premix | g | 2347 | 293.2 | 293.26 |
| Potassium Chloride | g | 1295 | 208.5 | 282.24 |
| Carrageenan | g | — | 175.0 | 240.00 |
| Ascorbic Acid | G | 1275 | 727.5 | 582.12 |
| Soy Lecithin | G | 1120 | 534.6 | 356.11 |
| Stabilizer | G | — | 534.6 | 356.11 |
| Vitamin/Mineral/Taurine Premix | G | 1116 | 142.8 | 142.77 |
| Taurine | G | 340.5 | 43.66 | 43.654 |
| m-Inositol | G | 247.9 | 31.70 | 31.695 |
| Zinc Sulfate | G | 114.2 | 14.62 | 14.617 |
| Niacinamide | G | 72.78 | 9.323 | 9.3157 |
| Calcium Pantothenate | G | 44.16 | 5.587 | 5.5860 |
| Ferrous Sulfate | G | 39.24 | 4.880 | 4.8870 |
| Cupric Sulfate | G | 13.68 | 1.714 | 1.7143 |
| Thiamine Chloride HCl | G | 11.30 | 1.445 | 1.4456 |
| Riboflavin | Mg | 4985 | 637.6 | 637.47 |
| Pyridoxine HCl | Mg | 4572 | 584.1 | 583.96 |
| Folic Acid | Mg | 1535 | 196.4 | 215.72 |
| Manganese Sulfate | Mg | 1306 | 166.3 | 166.25 |
| Biotin | Mg | 441.0 | 56.41 | 56.390 |
| Sodium Selenate | Mg | 261.8 | 33.82 | 33.820 |
| Cyanocobalamin | Mg | 35.17 | 4.493 | 4.500 |
| DHA Oil | G | 1113 | 135.4 | 130.01 |
| Magnesium Chloride | G | 1038 | 141.5 | 140.46 |
| Sodium Chloride | G | 579.4 | as needed | as needed |
| Ferrous Sulfate | G | 453.6 | 58.02 | 58.03 |
| Choline Chloride | G | 432.1 | 54.02 | 50.02 |
| Vitamin A, D3, E, K1 | G | 377.2 | 47.50 | 44.76 |
| RRR Alpha-Tocopheryl Acetate | G | 76.23 | 9.604 | 9.0507 |
| Vitamin A Palmitate | G | 14.32 | 1.803 | 1.6998 |
| Vitamin K1 | Mg | 829.3 | 104.5 | 98.47 |
| Vitamin D3 | Mg | 100.4 | 12.65 | 11.92 |
| Citric Acid | G | — | 29.80 | 29.77 |
| Ascorbyl Palmitate | G | 361.3 | — | — |
| Carotenoid Premix | G | 350.1 | 23.80 | 42.91 |
| Lycopene | Mg | 1720 | 119.0 | 214.55 |
| Lutein | Mg | 735 | 49.98 | 90.11 |
| Beta-Carotene | Mg | 385 | 26.18 | 47.201 |
| Mixed Tocopherols | G | 159.2 | — | — |
| Mixed Tocopherols | G | 111.4 | — | — |
| L-Carnitine | G | 26.30 | 3.285 | 3.28 |
| Riboflavin | G | 3.181 | 1.166 | 1.4994 |
| Tricalcium Phosphate | G | 0-5230 | 12.5 | 41.89 |
| Potassium Phosphate Monobasic | G | — | 11.01 | 36.60 |
| Vitamin A Palmitate | Mg | — | — | 776.16 |
| Vitamin A Palmitate | Mg | — | — | 427.19 |
| Alpha Tocopherol | Mg | — | — | 7.760 |
| Potassium Phosphate Dibasic | Kg | 0-5.23 | — | — |
| 1N KOH | Kg | as needed | 1.583 | as needed |
| Potassium Hydroxide | G | as needed | 79.15 | as needed |

Control Formula 1 was prepared as described above in Examples 12-15; Control Formula 2 was prepared as described above in Examples 1-8, and Control Formula 3 was prepared as described above in Examples 9-11.

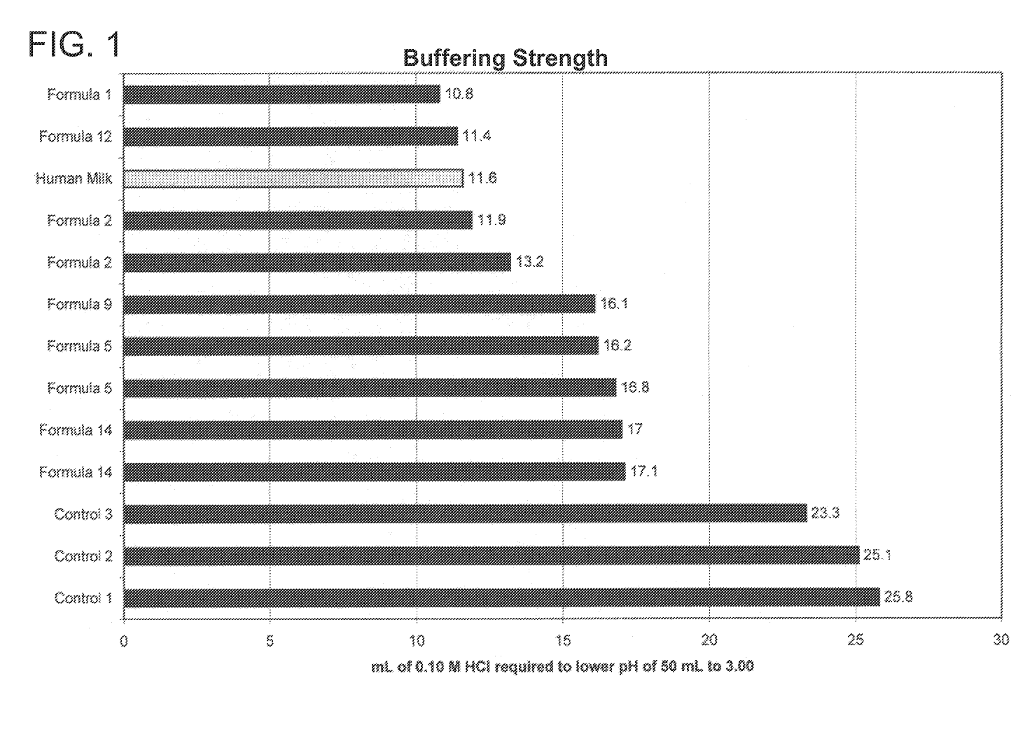

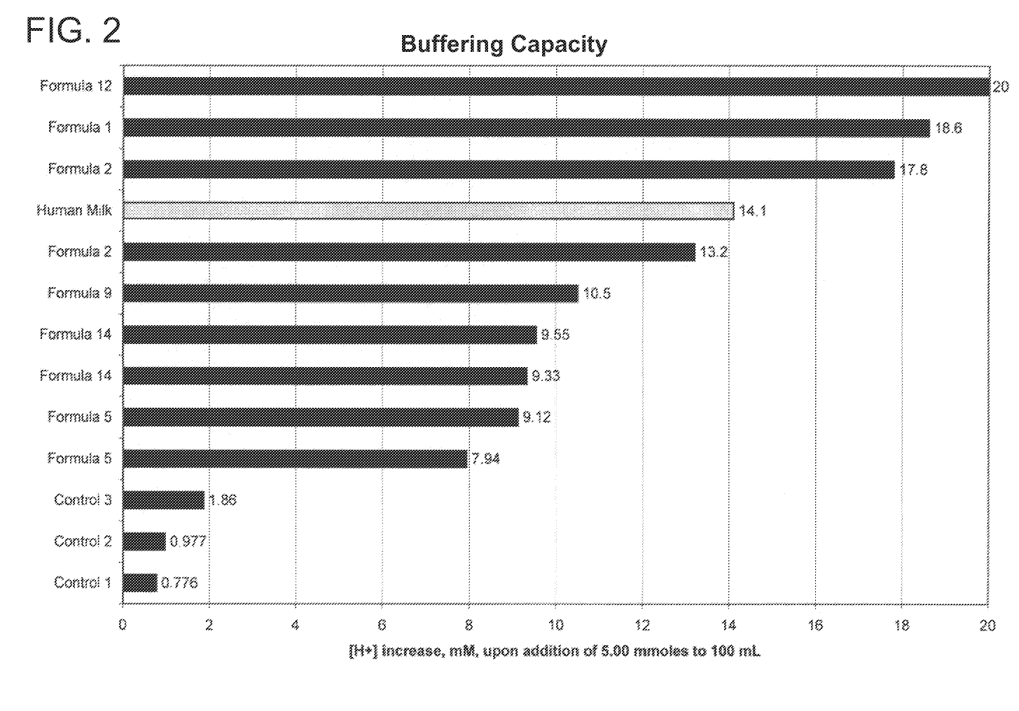

The buffering capacity and buffering strength of various days 1-2 ready-to-feed (RTF) retort sterilized or reconstituted powder formulas and days 3-9 RTF retort sterilized, RTF aseptic sterilized, or reconstituted powder formulas was determined and compared to that of Control Formulas 1-3 and to that of human milk. Specifically, the buffering strength of the formulas (or human milk) was determined by adding 0.5 mL aliquots of 0.10 M HCl to 50 mL of each formula (or reconstituted formula, in the case of powder formula) at one minute intervals. The pH of each formula was measured after each aliquot addition. Buffering strength is reported as mL of 0.10 M HCl required to lower the pH of 50 mL of formula to 3.0. The buffering capacity of the formulas (or human milk) was determined by adding 5.00 mmoles of HCl to 100 mL of each formula (or reconstituted formula, in the case of powder formula). The buffering capacity is reported as the increase in [H+] following the HCl addition. The results are shown in Table 6 below and in FIGS. 1 and 2.

TABLE 6

| | Energy | | Buffering | Buffering |
|---|---|---|---|---|
| Formula | (kcal/L) | Form | Strength^{d} | Capacity^{e} |
| Control Formula 1 | 676 | powder^{a} | 25.8 | 0.776 mM |
| Formula 14 (days 3-9) | 406 | powder^{a} | 17.1 | 9.55 mM |
| Formula 14 (days 3-9)^{c} | 406 | powder^{b} | 17.0 | 9.33 mM |
| Formula 12 (days 1-2) | 270 | powder^{b} | 11.4 | 20.0 mM |
| Control Formula 2 | 676 | retort | 25.1 | 0.977 mM |
| Formula 5 (days 3-9) | 406 | retort | 16.8 | 7.94 mM |
| Formula 5 (days 3-9)^{c} | 406 | retort | 16.2 | 9.12 mM |
| Formula 2 (days 1-2) | 270 | retort | 13.2 | 13.2 mM |
| Formula 2 (days 1-2)^{c} | 270 | retort | 11.9 | 17.8 mM |
| Formula 1 (days 1-2) | 270 | retort | 10.8 | 18.6 mM |
| Control Formula 3 | 676 | aseptic | 23.3 | 1.86 mM |
| Formula 9 (days 3-9) | 406 | aseptic | 16.1 | 10.5 mM |
| Human Milk | | | 11.6 | 14.1 mM |

^{a}Control Formula 1 was reconstituted using 35.0 g of formula plus 240 mL of water prior to determination of buffering capacity and buffering strength.
^{b}Formulas 12 and 14 were reconstituted using 12.2 g of formula and 21.4 g of formula, respectively, plus 240 mL of water prior to determining buffering capacity and buffering strength.
^{c}Formulas 2, 5, and 14 were tested twice.
^{d}as mL of 0.10M HCl required to lower the pH of 50 mL of formula to 3.0.
^{e}as increase in [H+] upon addition of 5.00 mmoles of HCl to 100 mL of formula.

As can be seen from these results, the buffering capacity of the formulations decreased with decreasing energy content. The days 1-2 formulas, which had an energy content of 270 kcal/L, had the lowest buffering capacity of all tested formulas. The buffering strength of human milk has been reported to range from 9.0 to 18.0, with an average of 13.5. As can be seen from the results set forth in Table 6 and FIGS. 1 and 2, the buffering strength of the days 1-2 formulas was comparable to or lower than that of the tested human milk.

The decreased buffering capacity and buffering strength of the formulas of the present disclosure, and especially of the days 1-2 formulas, may offer physiological benefits to infants. In particular, decreased buffering capacity and strength may assist with achieving a more beneficial gut microflora distribution, and may increase the effectiveness of the inactivation of orally ingested intestinal pathogens.

### Example 17

In this example, the effect of energy content on the buffering capacity and buffering strength of infant formula was evaluated. Specifically, the buffering capacity and buffering strength of days 1-2 (Formula 13) and days 3-9 (Formula 15) powder infant formulas of the present disclosure was determined following reconstitution and compared to the buffering capacity and buffering strength of a commercially available powder control infant formula (Control Formula 1) following reconstitution.

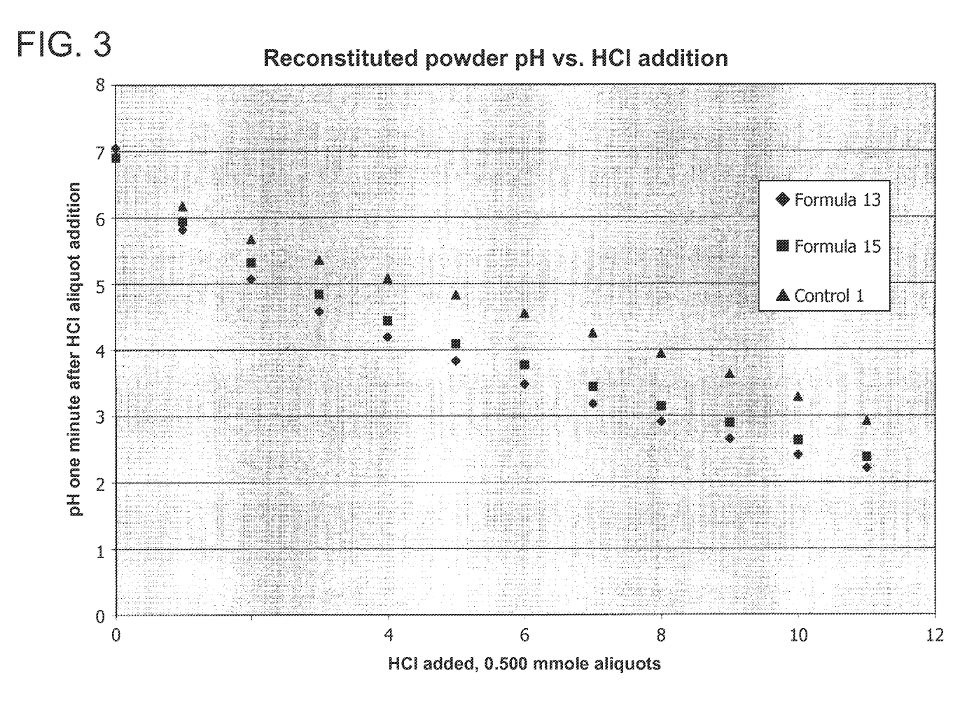

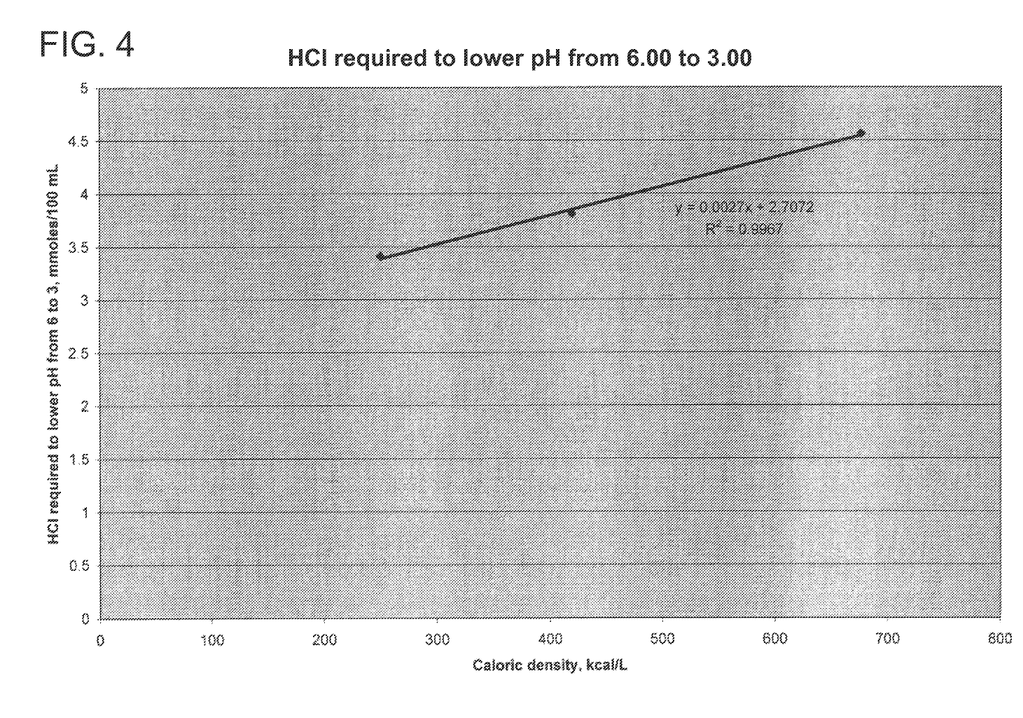

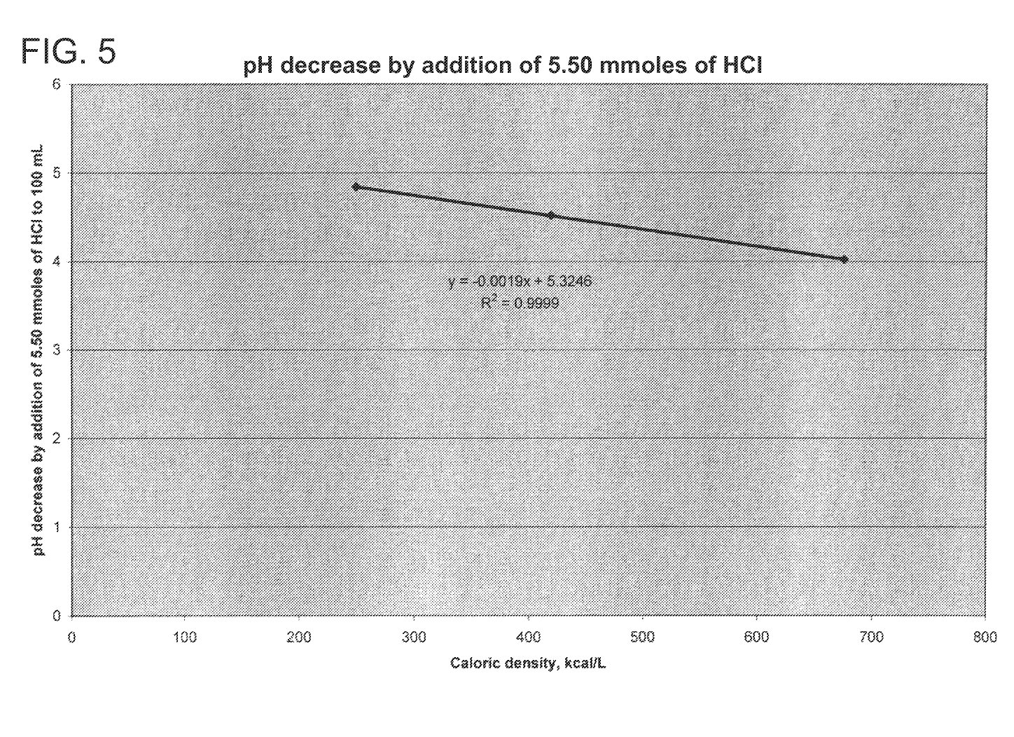

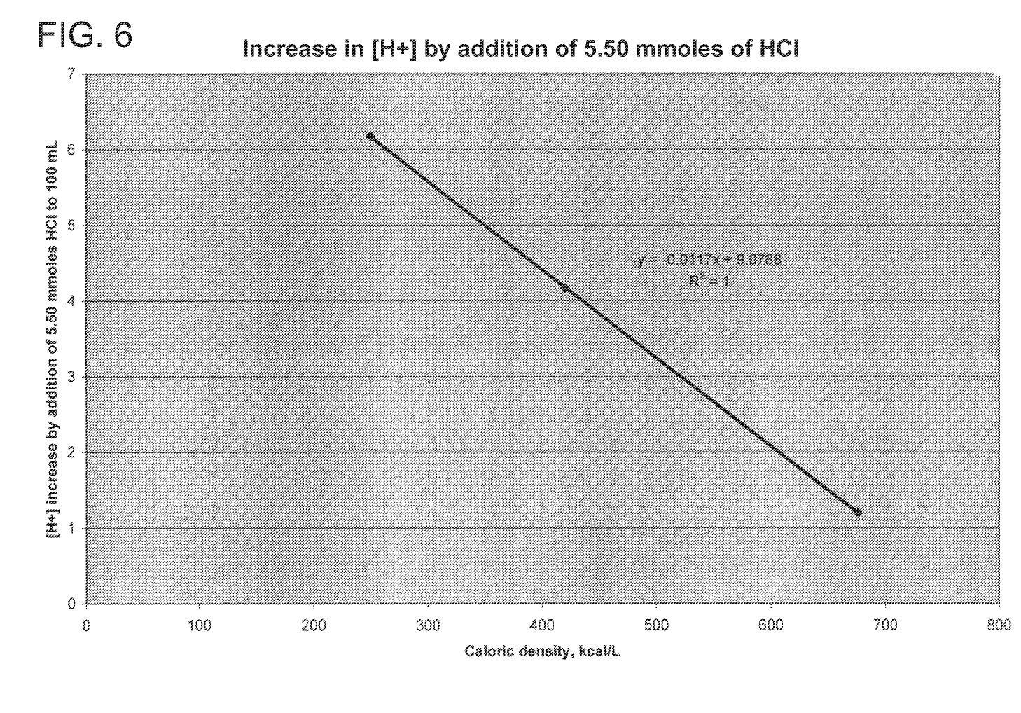

Formula 13 was reconstituted using 12.2 g of formula plus 240 mL of water, Formula 15 was reconstituted using 21.4 g of formula plus 240 mL of water, and Control Formula 1 was reconstituted using 35.0 g of formula plus 240 mL of water. The buffering capacity and buffering strength of each formula was determined. Specifically, the buffering strength of the formulas was determined by adding 1.00 mL aliquots of 0.500 M HCl to 100 mL of reconstituted formula at one minute intervals. The pH of each formula was measured after each aliquot addition. Buffering strength is reported as mmoles of HCl required to lower the pH of 100 mL of the reconstituted formula from 6.00 to 3.00. The buffering capacity of the formulas was determined by adding 5.50 mmoles of HCl to 100 mL of each reconstituted formula. The buffering capacity is reported as the increase in [H+] following the HCl addition and the pH decrease following the HCl addition. The results are shown in Table 7 below and in FIGS. 3-6.

TABLE 7

| | Formula 13 | Formula 15 | Control |
|---|---|---|---|
| | (days 1-2) | (days 3-9) | Formula 1 |
| Kcal/L | 250 | 420 | 676 |
| Buffering Strength | 3.41 | 3.81 | 4.56 |
| (mmoles) | | | |
| Buffering Capacity- | 4.84 | 4.52 | 4.02 |
| pH decrease | | | |
| Buffering Capacity- | 6.17 mM | 4.17 mM | 1.20 mM |
| increase in [H+] | | | |

As can be seen from the results set forth in Table 7 and in FIGS. 3-6 both the buffering strength and the buffering capacity (as measured by both pH decrease and increase in [H+]) of the days 1-2 and days 3-9 formulas were significantly lower than that of the control formula. The days 1-2 formula, which had an energy content of 250 kcal/L, had the lowest buffering capacity and buffering strength of all tested formulas, indicating that buffering strength and buffering capacity decreased with decreasing energy content.

### Example 18

In this example, the effect of energy content on the buffering capacity and buffering strength of infant formula was evaluated. Specifically, the buffering capacity and buffering strength of a 2 oz. retort sterilized days 1-2 infant formula of the present disclosure (Formula 3) was determined and compared to the buffering capacity and buffering strength of a 2 oz. commercially available retort sterilized control infant formula (Control Formula 2).

The buffering capacity and buffering strength of each formula was determined. Specifically, the buffering strength of the formulas was determined by adding 0.50 mL aliquots of 0.500 M HCl to 50 mL of each formula at one minute intervals. The pH of each formula was measured after each aliquot addition. Buffering strength is reported as mmoles of HCl required to lower the pH of 50 mL of the formula from 6.00 to 3.00. The buffering capacity of the formulas was determined by adding 2.75 mmoles of HCl to 50 mL of each formula. The buffering capacity is reported as the increase in [H+] following the HCl addition and the pH decrease following the HCl addition. The results are shown in Table 8 below.

TABLE 8

| | Formula 3 | Control |
|---|---|---|
| | (days 1-2) | Formula 2 |
| Kcal/L | 250 | 676 |
| Buffering Strength | 1.53 | 2.28 |
| (mmoles) | | |
| Buffering Capacity- | 4.34 | 4.13 |
| pH decrease | | |
| Buffering Capacity- | 10.7 mM | 3.72 mM |
| increase in [H+] | | |

As can be seen from the results set forth in Table 8, both the buffering strength and the buffering capacity (as measured by both pH decrease and increase in [H+]) of the days 1-2 formula were significantly lower than that of the control formula, indicating that buffering strength and buffering capacity of the low calorie days 1-2 retort sterilized formula of the present disclosure are lower than that of a conventional full calorie infant formula.

### Example 19

In this example, the effect of energy content on the buffering capacity and the buffering strength of infant formula was evaluated. Specifically, the buffering capacity and buffering strength of a 32 oz. aseptic sterilized days 3-9 infant formula of the present disclosure (Formula 11) was determined and compared to the buffering capacity and buffering strength of a 32 oz. commercially available aseptic sterilized control infant formula (Control Formula 3).

The buffering capacity and buffering strength of each formula was determined. Specifically, the buffering strength of the formulas was determined by adding 1.00 mL aliquots of 0.500 M HCl to 100 mL of each formula at one minute intervals. The pH of each formula was measured after each aliquot addition. Buffering strength is reported as mmoles of HCl required to lower the pH of 100 mL of the formula from 6.00 to 3.00. The buffering capacity of the formulas was determined by adding 5.50 mmoles of HCl to 100 mL of each formula. The buffering capacity is reported as the increase in [H+] following the HCl addition and the pH decrease following the HCl addition. The results are shown in Table 9 below.

TABLE 9

| | Formula 11 | Control |
|---|---|---|
| | (days 3-9) | Formula 3 |
| Kcal/L | 410 | 676 |
| Buffering Strength | 3.46 | 3.84 |
| (mmoles) | | |
| Buffering Capacity- | 4.78 | 4.54 |
| pH decrease | | |
| Buffering Capacity- | 8.51 mM | 5.50 mM |
| increase in [H+] | | |

As can be seen from the results set forth in Table 9, both the buffering strength and the buffering capacity (as measured by both pH decrease and increase in [H+]) of the days 3-9 formula were significantly lower than that of the control formula, indicating that buffering strength and buffering capacity of the low calorie days 3-9 aseptic sterilized formula of the present disclosure is lower than that of a conventional full calorie infant formula.

### Example 20

In this example, the effect of the energy content of infant formula on the rate and extent of protein hydrolysis was evaluated. Specifically, the extent of protein hydrolysis of reconstituted days 1-2 (Formula 13) and reconstituted days 3-9 (Formula 15) powdered infant formulas of the present disclosure was determined following an in vitro gastrointestinal digestion, and compared to the extent of protein hydrolysis of a reconstituted powder control infant formula (Control Formula 1).

Formula 13 was reconstituted using 12.2 g of formula plus 240 mL of water, Formula 15 was reconstituted using 21.4 g of formula plus 240 mL of water, and Control Formula 1 was reconstituted using 35.0 g of formula plus 240 mL of water. Digests were prepared by subjecting the reconstituted formulas to an in vitro gastrointestinal digestion. Specifically, the pH of 40 mL of each reconstituted formula was adjusted to 4.5 using 6 M HCl. 1.00 mL of USP pepsin, prepared in 56 mg/mL of water, was added to the formula, and the resulting mixture was stirred at room temperature for one hour. The pH of the mixture was then adjusted to 7.2 using 10 N NaOH. 4.00 mL of USP pancreatin amylase/protease, prepared in 6.94 mg/mL water, plus USP pancreatin lipase, prepared in 6.94 mg/mL water, was then added, and the mixture was stirred at room temperature for two hours. The resulting digests were centrifuged at 31,000×g at 20° C. for 4 hours.

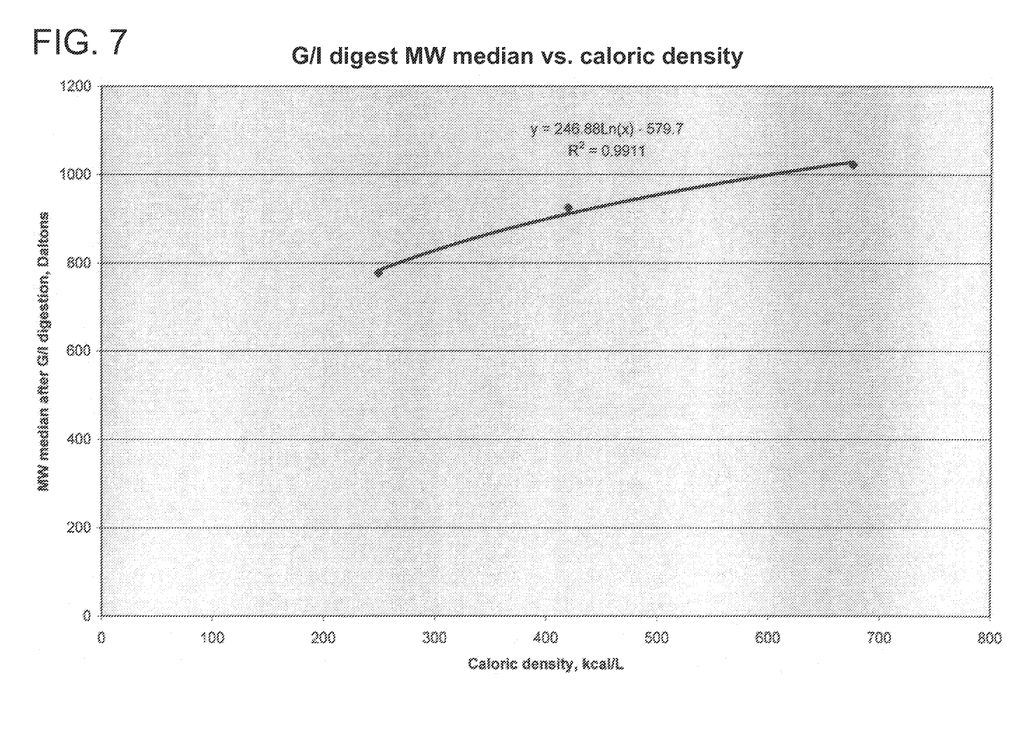

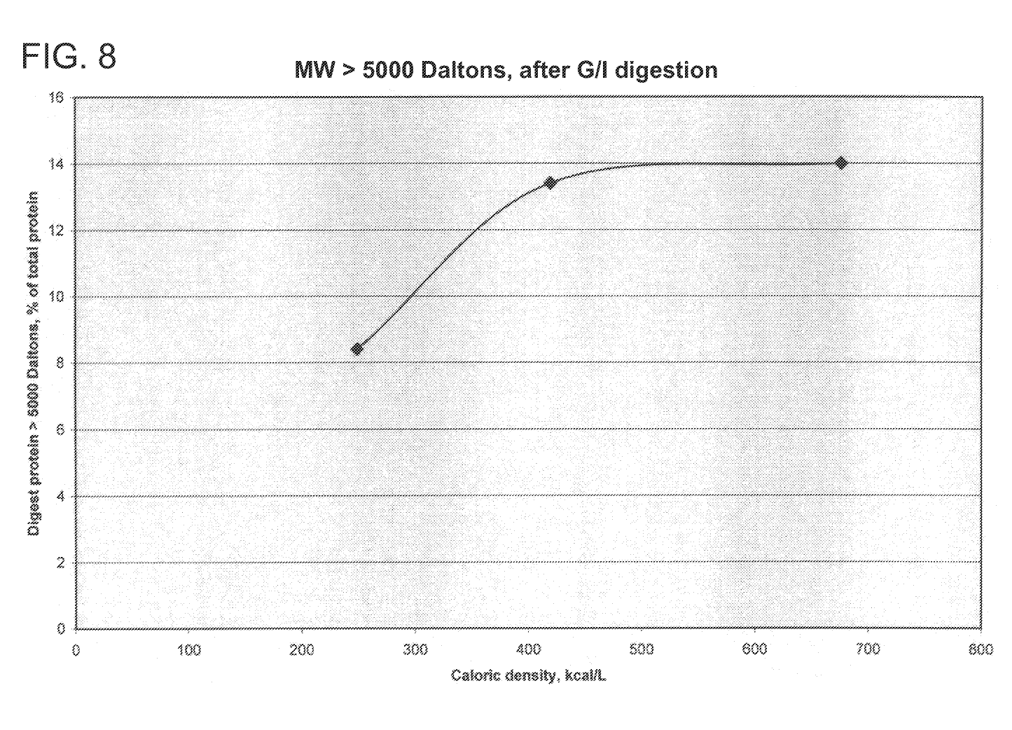

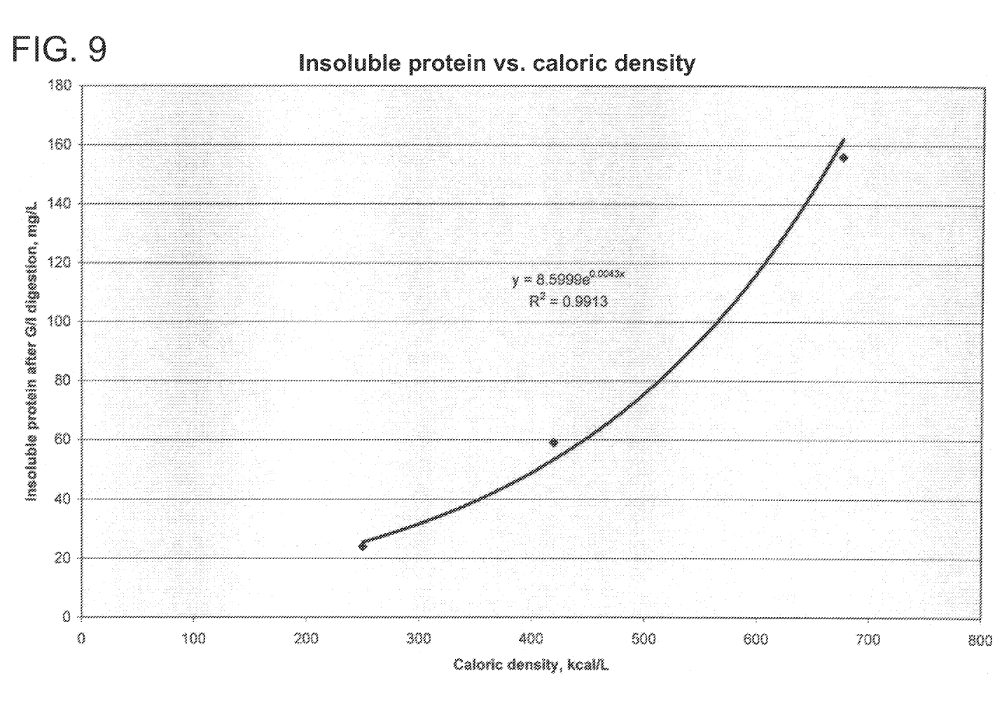

The supernatant was analyzed by HPLC using a Superdex® Peptide 10/300 GL gel filtration column (Amersham Biosciences). Specifically, 5 mg of the supernatant was added to 1 mL of a mobile phase solution (700 mL Milli-Q® water, 300 mL acetonitrile, 1.00 mL TFA) and the resulting solution was run at ambient temperature on the Superdex® column (flow rate: 0.4 mL/minute; detection: UV at 205 nm; injection: 10 μL; run time: 80 minutes) to determine the molecular weight median of the protein in the digests and the amount of protein having a molecular weight of greater than 5000 Daltons, as a percentage of total protein, in the digests. These determinations are indicators of the extent of protein digestion. The pellet produced following centrifugation of the digests was also tested for the presence of insoluble protein using acid hydrolysis/amino acid profile using conventional methods. The results are shown in Table 10 below and in FIGS. 7-9.

TABLE 10

| | Formula 13 | Formula 15 | Control |
|---|---|---|---|
| | (days 1-2) | (days 3-9) | Formula 1 |
| Kcal/L | 250 | 420 | 676 |
| Protein MW median (Da) | 777 | 925 | 1022 |
| Protein >5000 Da | 8.4% | 13.4% | 14.0% |
| (% total protein) | | | |
| Insoluble protein^{a} (mg/L) | 24 | 59 | 156 |

^{a}total protein in the pellet after high speed centrifugation of the digest

As can be seen from these results, the protein hydrolysis was more extensive in the days 1-2 and days 3-9 formulas than in the control formula. Further, all three digestion indicators (protein MW median, amount of protein >5000 Da, and amount of insoluble protein) decreased with decreasing energy content. These results indicate that the rate of protein digestion is inversely correlated with energy content.

### Example 21

In this example, the effect of the energy content of infant formula on the rate and extent of protein hydrolysis was evaluated. Specifically, the extent of protein hydrolysis of a 2 oz. retort sterilized days 1-2 infant formula of the present disclosure (Formula 3) was determined following an in vitro gastrointestinal digestion, and compared to the extent of protein hydrolysis of a 2 oz. commercially available retort sterilized control infant formula (Control Formula 2).

Digests were prepared by subjecting the formulas to an in vitro gastrointestinal digestion using the procedure set forth in Example 20. The digests were centrifuged at 31,000×g at 20° C. for 4 hours. The supernatant was analyzed by HPLC using a Superdex® Peptide 10/300 GL gel filtration column (Amersham Biosciences) using the procedure set forth above in Example 20, and the molecular weight median of the protein in the digests and the amount of protein having a molecular weight of greater than 5000 Daltons, as a percentage of total protein, in the digests was determined. The pellet produced following centrifugation of the digests was also tested for the presence of insoluble protein using the acid hydrolysis/amino acid profile technique described in Example 20. The results are shown in Table 11 below.

The digests were also tested for the presence of the Maillard reaction marker furosine using acid hydrolysis and HPLC. These results are also shown in Table 11 below.

TABLE 11

| | Formula 3 | Control |
|---|---|---|
| | (days 1-2) | Formula 2 |
| Kcal/L | 250 | 676 |
| Protein MW median (Da) | 789 | 992 |
| Protein >5000 Da (% total protein) | 3.77% | 8.81% |
| Insoluble protein^{a} (mg/L) | 48 | 471 |
| Furosine (mole % of total lysine) | 0.84% | 2.61% |

^{a}total protein in the pellet after high speed centrifugation of the digest

As can be seen from these results, the protein hydrolysis was more extensive in the days 1-2 formula than in the control formula. All three digestion indicators (protein MW median, amount of protein >5000 Da, and amount of insoluble protein) decreased with decreasing energy content. These results indicate that the rate of protein digestion is inversely correlated with energy content. Further, the days 1-2 formula had lower levels of the Maillard reaction marker furosine than did the control formula. These results suggest that the low calorie days 1-2 retort sterilized formulas of the present disclosure are less susceptible to Maillard reactions than conventional full calorie infant formulas.

### Example 22

In this example, the effect of the energy content of infant formula on the rate and extent of protein hydrolysis was evaluated. Specifically, the extent of protein hydrolysis of a 32 oz. aseptic sterilized days 3-9 infant formula of the present disclosure (Formula 11) was determined following an in vitro gastrointestinal digestion, and compared to the extent of protein hydrolysis of a 32 oz. commercially available aseptic sterilized control infant formula (Control Formula 3).

Digests were prepared by subjecting the formulas to an in vitro gastrointestinal digestion using the procedure set forth in Example 20. The digests were centrifuged at 31,000×g at 20° C. for 4 hours. The supernatant was analyzed by HPLC using a Superdex® Peptide 10/300 GL gel filtration column (Amersham Biosciences) using the procedure set forth above in Example 20, and the molecular weight (MW) median of the protein in the digests and the amount of protein having a molecular weight of greater than 5000 Daltons, as a percentage of total protein, in the digests was determined. The pellet produced following centrifugation of the digests was also tested for the presence of insoluble protein using the acid hydrolysis/amino acid profile technique described in Example 20. The results are shown in Table 12 below.

TABLE 12

| | Formula 11 | Control |
|---|---|---|
| | (days 3-9) | Formula 3 |
| Kcal/L | 410 | 676 |
| Protein MW median (Da) | 799 | 978 |
| Protein >5000 Da (% total protein) | 2.5% | 9.5% |
| Insoluble protein^{a} (mg/L) | 110 | 400 |

^{a}total protein in the pellet after high speed centrifugation of the digest

As can be seen from these results, the protein hydrolysis was more extensive in the days 3-9 formula than in the control formula. All three digestion indicators (protein MW median, amount of protein >5000 Da, and amount of insoluble protein) decreased with decreasing energy content. These results indicate that the rate of protein digestion is inversely correlated with energy content.

### Example 23

In this example, the effect of the energy content of infant formula on the rate and extent of protein hydrolysis was evaluated. Specifically, the extent of protein hydrolysis of reconstituted days 1-2 (Formula 13) and reconstituted days 3-9 (Formula 15) powdered infant formulas of the present disclosure was determined following digestion with pancreatin, and compared to the extent of protein hydrolysis of a reconstituted commercially available powder control infant formula (Control Formula 1) following pancreatin digestion.

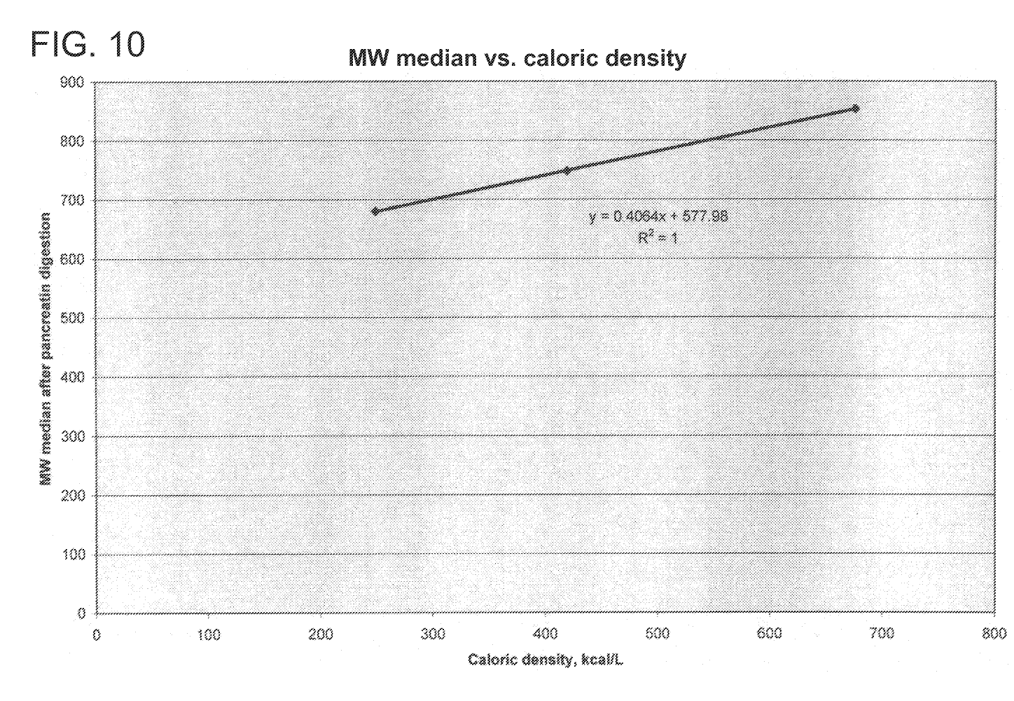

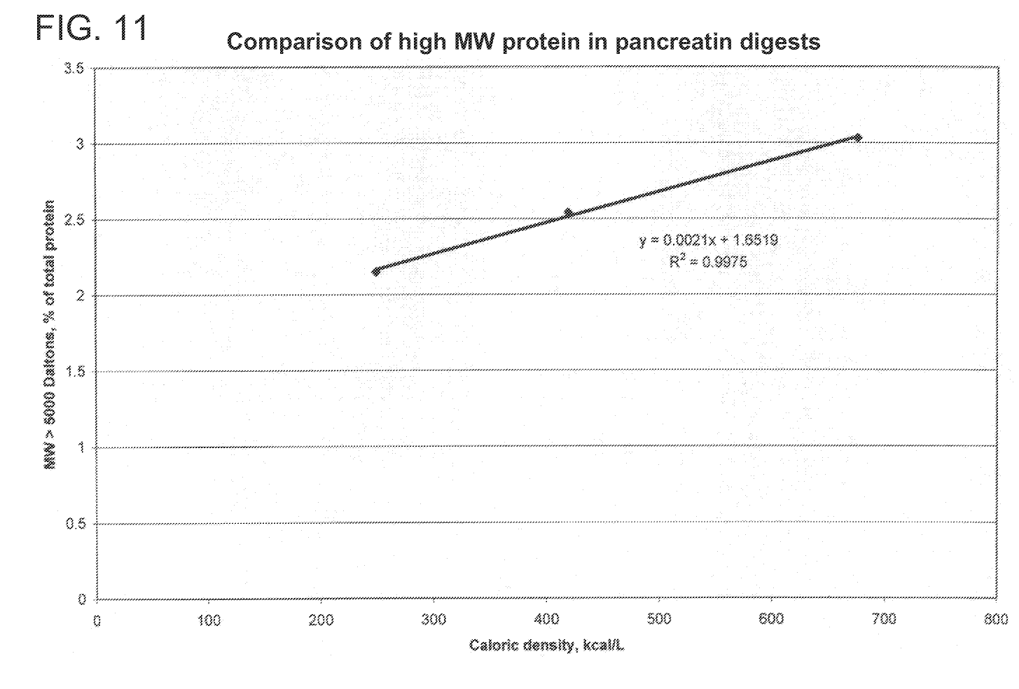

Formula 13 was reconstituted using 12.2 g of formula plus 240 mL of water, Formula 15 was reconstituted using 21.4 g of formula plus 240 mL of water, and Control Formula 1 was reconstituted using 35.0 g of formula plus 240 mL of water. Digests were prepared by subjecting the reconstituted formulas to digestion with pancreatin. Specifically, 9.00 mL of 0.05 M NaH₂PO₄ (pH 7.5) was added to 9.00 mL of each formula in a 20 mL vial. 2.00 mL of porcine pancreatin, prepared at 4.0 g/L in pH 7.5 buffer, was added to the formula, and the vial was placed in a 37° C. water bath for 71 minutes. After 71 minutes, a 1.5 mL aliquot of the mixture was transferred into an HPLC autosampler vial, and the vial was crimp sealed. The sealed vial was placed in a 100° C. heating module for 5 minutes to terminate the pancreatin digestion. 0.400 mL of the resulting digest was diluted with 1.00 mL of 8.30/6.00/0.02 (v/v) of water/acetonitrile/trifluoroacetic acid. The diluted digest was centrifuged at 14,000×g at room temperature for 5 minutes. The supernatant was analyzed by HPLC using a Superdex® Peptide 10/300 GL gel filtration column (Amersham Biosciences) using the procedure set forth above in Example 20, and the molecular weight (MW) median of the protein in the digests and the amount of protein having a molecular weight of greater than 5000 Daltons, as a percentage of total protein, in the digests was determined. The results are shown in Table 13 below and in FIGS. 10 and 11.

TABLE 13

| | Formula 13 | Formula 15 | Control |
|---|---|---|---|
| | (days 1-2) | (days 3-9) | Formula 1 |
| Kcal/L | 250 | 420 | 676 |
| Protein MW median (Da) | 680 | 748 | 853 |
| Protein >5000 Da (% total | 2.15% | 2.54% | 3.03% |
| protein) | | | |

As can be seen from these results, the protein hydrolysis was more extensive in the days 1-2 and days 3-9 formulas than in the control formula. Further, both digestion indicators (protein MW median, amount of protein >5000 Da) decreased with decreasing energy content. These results indicate that the rate of protein digestion is inversely correlated with energy content.

### Example 24

In this example, the effect of the energy content of infant formula on the rate and extent of protein hydrolysis was evaluated. Specifically, the extent of protein hydrolysis of a 2 oz. retort sterilized days 1-2 infant formula of the present disclosure (Formula 3) was determined before and after pancreatin digestion, and compared to the extent of protein hydrolysis of a 2 oz. commercially available retort sterilized control infant formula (Control Formula 2) before and after pancreatin digestion.

Digests were prepared by subjecting the formulas to pancreatin digestion using the same procedure as set forth in Example 23, except the infant formula/pancreatin mixture was held in the 37° C. water bath for only 60 minutes. The diluted digests were centrifuged at 14,000×g at room temperature for 5 minutes. The supernatant as well as a sample of the infant formulas prior to digestion were analyzed by HPLC using a Superdex® Peptide 10/300 GL gel filtration column (Amersham Biosciences) using the procedure set forth above in Example 20, and the molecular weight median of the protein in the infant formula prior to digestion and the molecular weight median of the protein following 60 minutes of pancreatin digestion was determined. The results are shown in Table 14 below.

TABLE 14

| | Formula 3 | Control |
|---|---|---|
| | (days 1-2) | Formula 2 |
| Kcal/L | 250 | 676 |
| Protein MW median | 14,774 | 19,120 |
| (Da) before digestion | | |
| Protein MW median | 801 | 1128 |
| (Da) after 60 min. digestion | | |

As can be seen from these results, the rate of protein hydrolysis was faster in the low calorie days 1-2 formula than in the control formula. Further, the MW median values at 60 minutes of pancreatin digestion were proportional to the caloric density of the infant formulas, indicating that protein digestion rate was inversely correlated to energy content.

### Example 25

In this example, the effect of the energy content of infant formulas on the rate and extent of protein hydrolysis was evaluated. Specifically, the extent of protein hydrolysis of reconstituted days 1-2 (Formula 12) or days 3-9 (Formula 14) powdered infant formulas, days 1-2 (Formulas 1 and 2) or days 3-9 (Formula 5) 2 oz. retort sterilized infant formula, and days 3-9 (Formula 9) 32 oz. aseptic sterilized infant formula of the present disclosure was determined following pancreatin digestion (powders) or in vitro GI digestion (liquids) and compared to the extent of protein hydrolysis of a reconstituted commercially available powder control infant formula (Control Formula 1), a 2 oz. commercially available retort sterilized control infant formula (Control Formula 2), and a 32 oz. commercially available aseptic sterilized control formula (Control Formula 3).

Formula 12 was reconstituted using 12.2 g of formula plus 240 mL of water, Formula 14 was reconstituted using 21.4 g of formula plus 240 mL of water, and Control Formula 1 was reconstituted using 35.0 g of formula plus 240 mL of water. Digests were prepared by subjecting the formulas (or reconstituted formulas) to pancreatin digestion using the same procedure as set forth above. The supernatant was analyzed by HPLC using a Superdex® Peptide 10/300 GL gel filtration column (Amersham Biosciences) using the procedure set forth above in Example 20, and the molecular weight (MW) median of the protein in the digests and the amount of protein having a molecular weight of greater than 5000 Daltons, as a percentage of total protein, in the digests was determined. The results are shown in Table 15 below.

TABLE 15

| | | | Protein MW | |
|---|---|---|---|---|
| | Energy | | >5000 Da (% | Protein MW |
| Formula | (kcal/L) | Form | total protein) | median (Da) |
| Control Formula 1 | 676 | powder | 17.9% | 1050 |
| Formula 14 (days 3-9)^{a} | 406 | powder | 10.9% | 846 |
| Formula 14 (days 3-9) | 406 | powder | 8.4% | 812 |
| Formula 12 (days 1-2) | 270 | powder | 5.2% | 717 |
| Control Formula 2 | 676 | retort | 13.7% | 988 |
| Formula 5 (days 3-9) | 406 | retort | 5.3% | 789 |
| Formula 1 (days 1-2) | 270 | retort | 3.9% | 730 |
| Formula 2 (days 1-2) | 270 | retort | 2.9% | 707 |
| Control Formula 3 | 676 | aseptic | 10.2% | 963 |
| Formula 9 (days 3-9) | 406 | aseptic | 4.1% | 801 |

^{a}Formula 14 was tested twice.

As can be seen from these results, the protein hydrolysis was more extensive in the days 1-2 and days 3-9 formulas than in the control formulas. Further, both digestion indicators (protein MW median, amount of protein >5000 Da) decreased with decreasing energy content. These results indicate that the rate of protein digestion is inversely correlated with energy content.

### Example 26

In this example, the effect of micronutrient content on the emulsion stability of days 1-2 retort sterilized infant formula and on days 3-9 aseptic sterilized infant formula was evaluated. Specifically, the emulsion stability of 32 oz. days 3-9 aseptic sterilized infant formulas having either a high (Formula 11) or low (Formula 9) micronutrient content and 2 oz. days 1-2 retort sterilized infant formulas having either a high (Formula 3) or low (Formula 1) micronutrient content was compared.

Protein loading levels, expressed as the protein percent of the cream layer formed following high speed centrifugation of the formula, were used to determine emulsion stability. Protein loading levels for each formula were determined by pouring 36-38 grams of formula into a tared 50 mL centrifugation tube, and capping the tubes. The capped tubes were then placed in a JA-20 fixed angle rotor (Beckman Coulter, P/N 334831), and the rotor was placed into a Beckman J2-HS centrifuge (Beckman Coulter). The samples were centrifuged at 31,000×g at 20° C. for 8 hours. Following centrifugation, a cream layer formed on the sample. The cream layer was transferred into a tared beaker, and its weight recorded. The supernatant was poured into a separate beaker, and the tube was reweighed to determine the weight of the pellet.

The amount of protein in the cream layer was determined using an acid hydrolysis/amino acid determination technique. The results are set forth in Table 16 below.

TABLE 16

| | | | | Protein % of |
|---|---|---|---|---|
| | | Micro- | | cream layer |
| | Energy | nutrient | | (approximate % |
| Formula | (kcal/L) | content | Form | w/w) |
| Formula 11 (days 3-9) | 410 | high | aseptic | 5.1% |
| Formula 9 (days 3-9) | 406 | low | aseptic | 4.7% |
| Formula 3 (days 1-2) | 250 | high | retort | 4.6% |
| Formula 1 (days 1-2) | 270 | low | retort | 5.9% |
| Average (n = 4) | | | | 5.1% ± 0.6% |

Protein loading values are indicators of emulsion stability. Specifically, emulsion stability generally increases with increasing protein loading values. As can be seen from the above-results, the protein loading values were higher in the days 1-2 retort sterilized formula having a low micronutrient content (i.e., Formula 1) than in the days 1-2 retort sterilized formula having a high micronutrient content (i.e., Formula 3). These results indicate that there is increased emulsion stability in days 1-2 retort sterilized formulas having low micronutrient content, as compared to comparable formulas having high micronutrient content. No significant difference in protein loading was seen between the high micronutrient content and low micronutrient content aseptic sterilized formulas.

### Example 27

In this example, the effect of micronutrient content on the emulsion stability of days 3-9 retort sterilized formulas was evaluated. Specifically, the emulsion stability of 2 oz. days 3-9 retort sterilized infant formulas having either a high (Formula 8) or low (Formula 6) micronutrient content was compared.

Protein loading levels, expressed as the protein percent of the cream layer formed following high speed centrifugation of the formula, were used to determine emulsion stability. Protein loading levels for each formula were determined using the procedure set forth in Example 26. The amount of cream layer, by weight of the whole product, and the amount of proteins in the cream layer, by weight of the whole product, were also calculated. The results are set forth in Table 17 below.

TABLE 17

| | | | | Cream layer |
|---|---|---|---|---|
| | | | Protein % of | protein % of |
| | Energy | Micronutrient | cream layer | whole product |
| Formula | (kcal/L) | content | (w/w) | (w/w) |
| Formula 6 | 406 | low | 6.9% | 0.35% |
| (days 3-9) | | | | |
| Formula 8 | 410 | high | 5.1% | 0.22% |
| (days 3-9) | | | | |

As can be seen from these results, the protein loading values were higher in Formula 6, which had a low micronutrient content, than in the high micronutrient formula (I.e., Formula 8). Formula 6 also formed a larger cream layer, and had a higher percentage of proteins in the cream layer, by weight of the whole product, than did Formula 8. These results indicate that there is increased emulsion stability in days 3-9 retort sterilized formulas having a low micronutrient content, as compared to comparable formulas having a high micronutrient content. The low micronutrient content days 3-9 retort sterilized formula (I.e., Formula 6) also had a higher protein loading value, and thus an increased emulsion stability, as compared to low micronutrient content days 1-2 retort sterilized formulas (see Formula 1, Example 26).

### Example 28

In this example, the effect of micronutrient content on the color of days 1-2 and days 3-9 retort sterilized formulas and on days 3-9 aseptic sterilized formulas was evaluated.

Color quality of the formulas was evaluated using the Agtron color method. The Agtron color method measures the percent of light reflected from the sample on a scale of 0 (black) to 100 (white) using a spectrophotometer. Brighter colored infant formulas, which are typically preferred by consumers, have a higher Agtron color score, while darker colored formulas have a lower score. The Agtron color scores for low and high micronutrient content retort and aseptic formulas of the present disclosure, measured at various time periods, are set forth in Table 18 (retort formulas) and Table 19 (days 3-9 aseptic formulas) below.

TABLE 18
Retort Formulas

| | Energy | Micronutrient | Time | Agtron color |
|---|---|---|---|---|
| Formula | (kcal/L) | content | interval | score (%)^{a} |
| Formula 3 | 250 | high | 0 days | 39.3 |
| (days 1-2) | | | 1 mo. | — |
| | | | 2 mo. | 33.3 |
| | | | 4 mo. | 30.2 |
| | | | 9 mo. | 28.5 |
| | | | 12 mo. | 28.2 |
| Formula 4 | 250 | high | 0 days | 44.1 |
| (days 1-2) | | | 1 mo. | — |
| | | | 3 mo. | 37.5 |
| | | | 6 mo. | 35.4 |
| | | | 9 mo. | 33.4 |
| | | | 12 mo. | 33.0 |
| Formula 1 | 270 | low | 0 days | 47.9 |
| (days 1-2) | | | 2 mo. | 43.7 |
| | | | 4 mo. | 42.2 |
| | | | 6 mo. | 40.3 |
| | | | 9 mo. | 38.6 |
| Formula 2 | 270 | low | 0 days | 54.4 |
| (days 1-2) | | | 3 mo. | 49.7 |
| | | | 6 mo. | 47.8 |
| Formula 8 | 410 | high | 0 days | 39.4 |
| (days 3-9) | | | | |
| Formula 5 | 406 | low | 0 days | 51.1 |
| (days 3-9) | | | 3 mo. | 48.8 |
| | | | 6 mo. | 46.0 |
| Formula 6 | 406 | low | 0 days | 45.3 |
| (days 3-9) | | | | |
| Formula 7 | 406 | low | 0 days | 46.2 |
| (days 3-9) | | | | |

(—) means not tested
^{a}Agtron color scores were determined using an Agtron M-45 spectrophotometer (blue filter - 436 nm) for all measurements.

TABLE 19
Days 3-9 Aseptic Formulas

| | Energy | Micronutrient | Time | Agtron color |
|---|---|---|---|---|
| Formula | (kcal/L) | content | interval | score (%)^{a} |
| Formula 11 | 410 | high | 0 days | 53.1 |
| | | | 1 mo. | 49.7 |
| | | | 2 mo. | — |
| | | | 4 mo. | — |
| | | | 12 mo. | 46.2 |
| Formula 10 | 410 | high | 0 days | 56.5 |
| | | | 1 mo. | — |
| | | | 3 mo. | 51.7 |
| | | | 6 mo. | 53.1 |
| | | | 9 mo. | 51.4 |
| | | | 12 mo. | 47.6 |
| Formula 9 | 406 | low | 0 days | 61.5 |
| | | | 1 mo. | — |
| | | | 2 mo. | 60.0 |
| | | | 6 mo. | 56.9 |
| | | | 9 mo. | 53.8 |

(—) means not tested
^{a}Agtron color scores were determined using an Agtron M-45 spectrophotometer (blue filter - 436 nm) for all measurements.

As can be seen from these results, the retort sterilized days 1-2 infant formulas having a low micronutrient content had a higher Agtron color score, and thus a brighter colored appearance, than retort sterilized days 1-2 infant formulas having a high micronutrient content. Similar results were obtained for the days 3-9 retort formulas and the days 3-9 aseptic formulas, where the low micronutrient content formulas had a higher Agtron color score than comparable formulas having a high micronutrient content. The improved color of the low micronutrient formulas, as compared to comparable high micronutrient formulas, was also observed even after extended periods of time, in some cases up to 9 months following product formulation. These results indicate that infant formulas of the present disclosure that have a low micronutrient content have a brighter and lighter colored appearance than comparable formulas that have a high micronutrient content.

### Example 29

In this example, the effect of micronutrient content on the particle size distribution and creaming velocity of retort sterilized days 1-2 formulas was evaluated.

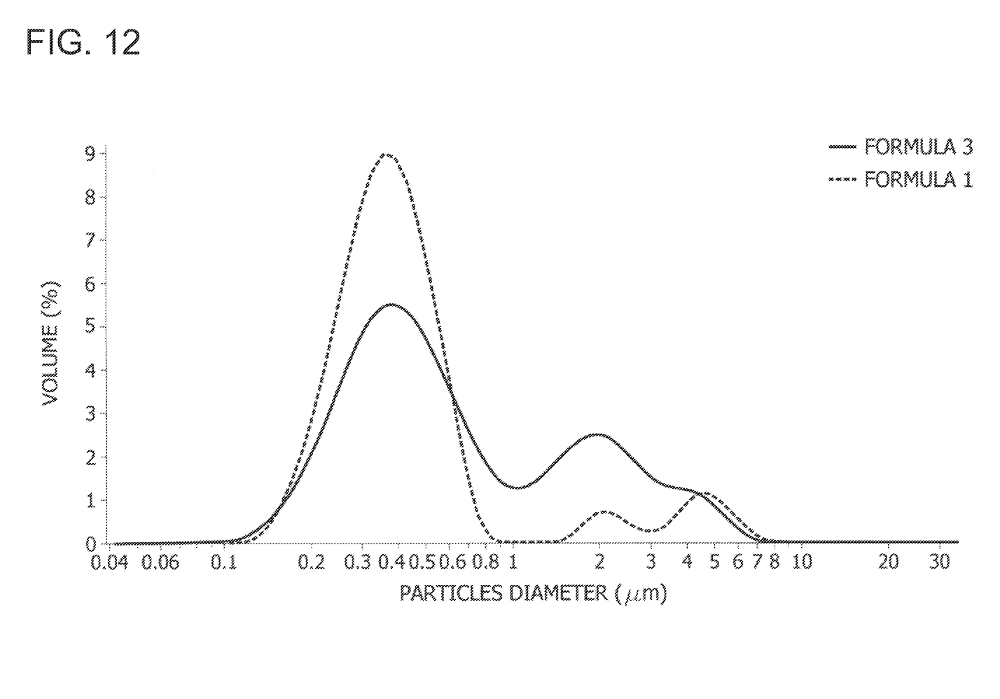

Specifically, the particle size distribution of 2 oz. retort sterilized days 1-2 formulas having either a high micronutrient content (Formula 3) or a low micronutrient content (Formula 1) was determined using a Beckman Coulter LS 13 320 light scattering machine. The results are shown in FIG. 12.

As can be seen from FIG. 12, the majority of the particles in the low micronutrient days 1-2 retort formula (Formula 1) were between about 0.1 μm and about 0.8 μm in size, with a smaller number of particles ranging from about 1 μm to about 8 μm. In contrast, the particle size distribution of the high micronutrient days 1-2 retort formula (Formula 3) ranged more equally from about 0.1 μm to about 7 μm.

The average particle size for each formula was determined from the particle size distribution and was used to calculate the creaming velocity of each formula. Specifically, the creaming velocity was calculated using the following equation:

$${v}_{cream} = \frac{2}{9} \frac{{ρ}_{fluid} - {ρ}_{particle}}{η} {gR}^{2}$$

wherein:
v_{cream} is the creaming velocity
ρ_{fluid} is the density of the formula
ρ_{particle} is the density of the particles
η is the viscosity of the formula
R is the average particle size
g is the gravitational acceleration

The density of the particles (e.g., oil droplets) was calculated by measuring the total surface area of the particles in a unit sample (100 mL) using a Beckman Coulter LS 13 320 light scattering machine. The volume of protein attached to the surface of the oil droplets was then measured using ultracentrifugation. The protein volume was then divided by the total surface area of the oil droplets to get the average thickness of the protein layer coated on each oil droplet. The average particle density was then calculated using 1.41 for the density of protein (Fischer, et al., Protein Science (2004), Vol. 13 (10), p. 2825-2828).

R² values and the creaming velocity for each formula are shown in Table 20.

TABLE 20
Particle Size and Creaming Velocity
of Days 1-2 Retort Formulas

| | | | Square of | Creaming |
|---|---|---|---|---|
| | Energy | Micronutrient | average particle | velocity |
| | (kcal/L) | content | size (R²) (μm²) | (cm/day) |
| Formula 1 | 270 | low | 1.8 | 3.2 |
| Formula 3 | 250 | high | 3.5 | 6.3 |

As can be seen from this table, the average particle size of the low micronutrient days 1-2 retort formula (Formula 1) was smaller than that of the high micronutrient days 1-2 retort formula (Formula 3). Since a smaller particle size may be representative of product stability, these results suggest that the low micronutrient days 1-2 retort formulas of the present disclosure have a greater product stability than comparable formulas having a high micronutrient content.

Creaming velocity measures the rate of movement of particles (e.g., droplets) through a liquid sample, in this instance, the infant formula, and is predictive of the capacity of the infant formula to form a cream layer. As can be seen from Table 20, the creaming velocity of the low micronutrient content days 1-2 retort formula was lower than that of the high micronutrient content days 1-2 retort formula. These results indicate that the low micronutrient content days 1-2 retort formulas of the present disclosure have a reduced capacity to form a cream layer, and thus have improved physical stability as compared to comparable high micronutrient formulas.

1-25. (canceled)

26. A low micronutrient infant formula comprising micronutrients and at least one macronutrient selected from the group consisting of protein, carbohydrate, fat, and combinations thereof, and having an energy content of 200 to less than 600 kilocalories per liter of formula,
where the micronutrients include at least a combination of copper, phosphorous, iron, calcium, and zinc, at least two of which are present in an amount of at least 20% less on a per volume basis than the following conventional amounts: 728 μg/L copper when in an infant formula in the form of an aseptic liquid, 676 μg/L copper when in an infant formula in the form of a retort liquid, 720 μg/L copper when in an infant formula in the form of a reconstituted powder; 341 mg/L phosphorous when in an infant formula in the form of an aseptic liquid, 349 mg/L phosphorous when in an infant formula in the form of a retort liquid, 332 mg/L phosphorous when in an infant formula in the form of a reconstituted powder; 13.7 mg/L iron when in an infant formula in the form of an aseptic liquid, 13.4 mg/L iron when in an infant formula in the form of a retort liquid, 13.9 mg/L iron when in an infant formula in the form of a reconstituted powder; 581 mg/L calcium when in an infant formula in the form of an aseptic liquid, 585 mg/L calcium when in an infant formula in the form of a retort liquid, 580 mg/L calcium when in an infant formula in the form of a reconstituted powder; 6.67 mg/L zinc when in an infant formula in the form of an aseptic liquid, 6.46 mg/L zinc when in an infant formula in the form of a retort liquid, and 6.69 mg/L zinc when in an infant formula in the form of a reconstituted powder.

27. An infant formula according to claim 26, wherein the formula is a retort sterilized liquid, an aseptically sterilized liquid, a concentrated liquid, or a powder.

28. An infant formula according to claim 26, wherein the energy content of the infant formula is 250 to 500 kilocalories per liter of formula.

29. An infant formula according to claim 26, comprising from 0.5 g to 1.0 g protein per 100 mL of formula, 1.2 g to 2.5 g fat per 100 mL of formula, and 2.7 g to 6.5 g carbohydrate per 100 mL of formula.

30. An infant formula according to claim 26, wherein the infant formula has a protein loading level of at least 5%.

31. An infant formula according to claim 26, wherein the infant formula has a creaming velocity of from 1 cm/day to 5 cm/day.

32. An infant formula according to claim 26, wherein the energy content of the infant formula is about 270 kilocalories per liter of formula.

33. An infant formula according to claim 26, wherein the infant formula has an energy content of 200 to 360 kilocalories per liter of formula.

34. An infant formula according to claim 33, wherein the infant formula is a days 1-2 infant formula.

35. An infant formula according to claim 26, wherein the infant formula has an energy content of 360 to 600 kilocalories per liter of formula.

36. An infant formula according to claim 35, comprising 0.76 g to 1.0 g protein per 100 mL of formula, 1.8 g to 2.5 g fat per 100 mL of formula, and 4.1 g to 6.5 g carbohydrate per 100 mL of formula.

37. An infant formula according to claim 35, wherein the infant formula is a days 3-9 infant formula.

38. An infant formula according to claim 26, wherein the infant formula has a buffering capacity expressed as the H+ concentration following addition of 5 mmoles of HCl to 100 mL of formula of 2 mM to 25 mM.

39. An infant formula according to claim 26, wherein the infant formula has a buffering strength expressed as the mL of 0.1 M HCl needed to decrease the pH of 50 mL of formula from a starting pH of 6.0 to a pH of 3.0 of 9 mL to 18 mL.

40. An infant formula according to claim 26, wherein the infant formula contains micronutrients in an amount that is low enough to provide the infant formula with an Agtron color score two months after formulation of at least 40.

41. A kit comprising:
at least one days 1-2 low micronutrient infant formula having an energy content of 200 to 360 kilocalories per liter of formula; and
at least one days 3-9 low micronutrient infant formula having an energy content of 360 to 600 kilocalories per liter of formula.

42. A method for providing nutrition to an infant, the method comprising administering to the infant a low micronutrient infant formula according to claim 26.
